(19) United States
(12) Patent Application Publication
(10) Pub. No.: US 2020/0027240 A1
(43) Pub. Date: Jan. 23, 2020

(54) Pedestrian Tracking Method and Electronic Device

(71) Applicant: Huawei Technologies Co., Ltd., Shenzhen (CN)

(72) Inventors: Yi Yang, Beijing (CN); Maolin Chen, Beijing (CN); Jianhui Zhou, Beijing (CN); Bo Bai, Beijing (CN)

(21) Appl. No.: 16/587,941

(22) Filed: Sep. 30, 2019

Related U.S. Application Data
(63) Continuation of application No. PCT/CN2018/079514, filed on Mar. 20, 2018.

(30) Foreign Application Priority Data
Mar. 31, 2017 (CN) 201710208767.7

(51) Int. Cl. G06T 7/73; G06T 7/194

(52) U.S. Cl. CPC G06T 7/74; G06T 2207/30196; G06T 2207/10016; G06T 7/194

(57) ABSTRACT

A pedestrian tracking method includes obtaining, within a detection period, an upper body detection box of a to-be-tracked pedestrian appearing in a to-be-tracked video; obtaining a detection period whole body box of the to-be-tracked pedestrian based on the upper body detection box; and obtaining, within the tracking period based on the detection period whole body box, a tracking period whole body box corresponding to an upper body tracking box. It can be learned that the to-be-tracked pedestrian may be tracked using the tracking period whole body box. An aspect ratio of the detection period whole body box may change. Therefore, even if the to-be-tracked pedestrian appears in an abnormal posture within the detection period, an accurate tracking period whole body box of the to-be-tracked pedestrian can still be obtained.

### CROSS-REFERENCE TO RELATED APPLICATIONS

This application is a continuation of International Patent Application No. PCT/CN2018/079514, filed on Mar. 20, 2018, which claims priority to Chinese Patent Application No. 201710208767.7, filed on Mar. 31, 2017. The disclosures of the aforementioned applications are hereby incorporated by reference in their entireties.

### TECHNICAL FIELD

The present disclosure relates to the field of communications technologies, and in particular, to a pedestrian tracking method and an electronic device.

### BACKGROUND

In the historical background of establishing a safe city, an intelligent video analysis system is increasingly concerned. The intelligent video analysis system needs to automatically and intelligently analyze pedestrians in massive video data, for example, calculate a motion trail of a pedestrian, detect an abnormal pedestrian entry in a restricted area, automatically detect a pedestrian on a road and remind a driver to avoid the pedestrian, and help the police to search for a criminal suspect through an image-based image search, in order to greatly improve work efficiency and reduce human costs.

To automatically extract pedestrians from massive video data, pedestrian detection and tracking algorithms need to be used. Pedestrian detection refers to inputting an image, automatically finding a pedestrian in the image using a detection algorithm, and providing a location of the pedestrian in a form of a rectangular box. The rectangular box is referred to as a detection box of the pedestrian. Because a pedestrian is in motion in a video, the pedestrian needs to be tracked using a pedestrian tracking algorithm, to obtain a location of the pedestrian in each frame in the video. The location is also provided in a form of a rectangular box, and the rectangular box is referred to as a tracking box of the pedestrian.

Disadvantages in other approaches are as follows. 1. The detection box is not accurate enough: An aspect ratio of the detection box of the pedestrian is fixed, and the whole body of the pedestrian is detected. Therefore, when the pedestrian appears in an abnormal posture, for example, the legs are wide open, and therefore the aspect ratio increases, the detection box of the pedestrian with the fixed aspect ratio is not accurate enough. 2. The detection box and the tracking box cannot capture a change of a posture of the pedestrian in a walking process: Because the pedestrian is in motion in the video, the posture of the pedestrian may greatly change in the walking process. This change is manifested as a change of an aspect ratio of a minimum bounding rectangular box of the pedestrian in a video image. The change of the posture of the pedestrian in the walking process cannot be captured based on the detection box with the fixed aspect ratio and the tracking box.

### SUMMARY

The present disclosure provides a pedestrian tracking method and an electronic device, such that tracking can be accurately implemented regardless of a change of a posture of a to-be-tracked pedestrian.

A first aspect of the embodiments of the present disclosure provides a pedestrian tracking method, including the following steps.

Step A: Determine a detection period and a tracking period of a to-be-tracked video.

Optionally, the detection period is included in the tracking period, and duration of the detection period is less than duration of the tracking period.

Optionally, the detection period shown in this embodiment may not be included in the tracking period, the detection period is before the tracking period, and duration of the detection period is less than duration of the tracking period.

Step B: Obtain an upper body detection box of a to-be-tracked pedestrian.

For example, the upper body detection box of the to-be-tracked pedestrian appearing in the to-be-tracked video is obtained within the detection period.

More specifically, a target image frame is first determined, and the target image frame is an image frame in which the to-be-tracked pedestrian appears.

When the target image frame is determined, the upper body detection box may be obtained in the target image frame.

Step C: Obtain a detection period whole body box of the to-be-tracked pedestrian.

For example, the detection period whole body box of the to-be-tracked pedestrian is obtained based on the upper body detection box.

Step D: Obtain an upper body tracking box of the to-be-tracked pedestrian.

For example, the upper body tracking box of the to-be-tracked pedestrian appearing in the to-be-tracked video is obtained within the tracking period.

In this embodiment, the detection period whole body box obtained within the detection period is initialized as a tracking target, such that the to-be-tracked pedestrian serving as the tracking target can be tracked within the tracking period.

Step E: Obtain a tracking period whole body box.

For example, the tracking period whole body box corresponding to the upper body tracking box is obtained based on the detection period whole body box.

The tracking period whole body box is used to track the to-be-tracked pedestrian.

Using the method shown in this embodiment, the obtained detection period whole body box is obtained based on the upper body detection box of the to-be-tracked pedestrian, and an aspect ratio of the detection period whole body box may change. Therefore, even if the to-be-tracked pedestrian appears in an abnormal posture within the detection period, an accurate tracking period whole body box of the to-be-tracked pedestrian can still be obtained using the method shown in this embodiment, such that preparations can still be made to track the to-be-tracked pedestrian when the to-be-tracked pedestrian appears in the abnormal posture.

With reference to the first aspect of the embodiments of the present disclosure, in a first implementation of the first aspect of the embodiments of the present disclosure, before step C, the following steps are further performed.

Step C01: Obtain a lower body scanning area.

In this embodiment, after the upper body detection box of the to-be-tracked pedestrian is obtained, the lower body scanning area of the to-be-tracked pedestrian may be obtained based on the upper body detection box of the to-be-tracked pedestrian.

Step C02: Obtain the detection period whole body box.

For example, if a lower body detection box is obtained by performing lower body detection in the lower body scanning area, the detection period whole body box is obtained based on the upper body detection box and the lower body detection box.

Using the method shown in this embodiment, the obtained detection period whole body box is obtained by combining the upper body detection box of the to-be-tracked pedestrian and the lower body detection box of the to-be-tracked pedestrian. It can be learned that an aspect ratio of the obtained detection period whole body box may change. Therefore, even if the to-be-tracked pedestrian appears in an abnormal posture within the detection period, for example, in a posture that the legs of the to-be-tracked pedestrian are wide open, and therefore a proportion of the upper body to the lower body of the to-be-tracked pedestrian changes, an accurate detection period whole body box of the to-be-tracked pedestrian can still be obtained by combining the obtained upper body detection box and the obtained lower body detection box, in order to prepare to track the to-be-tracked pedestrian.

With reference to the first implementation of the first aspect of the embodiments of the present disclosure, in a second implementation of the first aspect of the embodiments of the present disclosure, the upper body detection box is RECTᵤ^{d}=[Lᵤ^{d},Tᵤ^{d},Rᵤ^{d},Bᵤ^{d}], where Lᵤ^{d} is an upper-left horizontal coordinate of the upper body detection box, Tᵤ^{d} is an upper-left vertical coordinate of the upper body detection box, Rᵤ^{d} is a lower-right horizontal coordinate of the upper body detection box, and Bᵤ^{d} is a lower-right vertical coordinate of the upper body detection box.

Step C01 includes the following steps.

Step C011: Determine a first parameter.

The first parameter is

$${B}_{f}^{estimate} = {B}_{u}^{d} - ( {B}_{u}^{d} - {T}_{u}^{d} ) * ( 1 - \frac{1}{{Ratio}_{default}} ) ,$$

where Ratio_{default} is a preset ratio.

Optionally, Ratio_{default} in this embodiment is pre-stored, and Ratio_{default} a may be preset based on an aspect ratio of a human body detection box. For example, if it is pre-determined that the aspect ratio of the human body detection box is 3:7, Ratio_{default} may be set to 3/7, and Ratio_{default} is stored, such that in a process of performing this step, Ratio_{default} can be extracted to calculate the first parameter B_{f}^{estimate}.

Step C012: Determine a second parameter.

The second parameter is Wᵤ^{d}=Rᵤ^{d}−Lᵤ^{d}.

Step C013: Determine a third parameter.

The third parameter H_{f}^{estimate}=the first parameter B_{f}^{estimate}−Tᵤ^{d}.

Step C014: Determine the lower body scanning area.

For example, the lower body scanning area may be determined based on the first parameter, the second parameter, and the third parameter.

It can be learned that, when the first parameter, the second parameter, and the third parameter are obtained, the lower body scanning area may be determined, such that the lower body detection box of the to-be-tracked pedestrian is detected in the obtained lower body scanning area, thereby improving accuracy and efficiency of obtaining the lower body detection box of the to-be-tracked pedestrian, and improving efficiency of tracking the to-be-tracked pedestrian.

With reference to the second implementation of the first aspect of the embodiments of the present disclosure, in a third implementation of the first aspect of the embodiments of the present disclosure, step C014 is performed as follows: The lower body scanning area is determined based on the first parameter, the second parameter, and the third parameter, where the lower body scanning area is ScanArea=[L^{s},T^{s},R^{s},B^{s}].

For example, L^{s} is an upper-left horizontal coordinate of the lower body scanning area, T^{s} is an upper-left vertical coordinate of the lower body scanning area, R^{s} is a lower-right horizontal coordinate of the lower body scanning area, and B^{s} is a lower-right vertical coordinate of the lower body scanning area.

More specifically, L^{s}=max{1, Lᵤ^{d}−Wᵤ^{d}/paral1}, T^{s}=max{1, Tᵤ^{d}+H_{f}^{estimate}/paral2}, R^{s}=min{imgW−1, Rᵤ^{d}+Wᵤ^{d}/paral2}, and B^{s}=min{imgH−1, B_{f}^{estimate}+H_{f}^{estimate}Wᵤ^{d}/paral3}, where paral1, paral2, and paral3 are preset values, and paral1, paral2, and paral3 may be empirical values, or operating staff may implement different settings of the lower body scanning area through different settings of paral1, paral1, and paral3; imgW is a width of any image frame of the to-be-tracked video within the detection period, and imgH is a height of any image frame of the to-be-tracked video within the detection period.

Using the method shown in this embodiment, the lower body detection box of the to-be-tracked pedestrian can be detected in the obtained lower body scanning area, in order to improve accuracy and efficiency of obtaining the lower body detection box of the to-be-tracked pedestrian, and improve efficiency of tracking the to-be-tracked pedestrian. In addition, in an obtaining process, different settings of the lower body scanning area may be implemented through different settings of the parameters (paral1, paral2, and paral3), in order to achieve high applicability of the method shown in this embodiment. In this way, in different application scenarios, different orientations of the lower body detection box may be implemented based on different settings of the parameters, in order to improve accuracy of detecting the to-be-tracked pedestrian.

With reference to the method according to any one of the first implementation of the first aspect of the embodiments of the present disclosure to the third implementation of the first aspect of the embodiments of the present disclosure, in a fourth implementation of the first aspect of the embodiments of the present disclosure, the lower body detection box is RECTₗ^{d}=[Lₗ^{d},Tₗ^{d},Rₗ^{d},Bₗ^{d}], where Lₗ^{d} is an upper-left horizontal coordinate of the lower body detection box, Tₗ^{d} is an upper-left vertical coordinate of the lower body detection box, Rₗ^{d} is a lower-right horizontal coordinate of the lower body detection box, and Bₗ^{d} is a lower-right vertical coordinate of the lower body detection box.

Step C includes the following steps.

Step C11: Determine an upper-left horizontal coordinate of the detection period whole body box.

For example, the upper-left horizontal coordinate of the detection period whole body box is L_{f}^{d}=min(Lᵤ^{d},Lₗ^{d}).

Step C12: Determine an upper-left vertical coordinate of the detection period whole body box.

For example, the upper-left vertical coordinate of the detection period whole body box is T_{f}^{d}=Tᵤ^{d}.

Step C13: Determine a lower-right horizontal coordinate of the detection period whole body box.

For example, the lower-right horizontal coordinate of the detection period whole body box is R_{f}^{d}=max (Rᵤ^{d}, Rₗ^{d}).

Step C14: Determine a lower-right vertical coordinate of the detection period whole body box.

For example, the lower-right vertical coordinate of the detection period whole body box is B_{f}^{d}=Bₗ^{d}.

Step C15: Determine the detection period whole body box.

For example, the detection period whole body box is RECT_{f}^{d}=[L_{f}^{d},T_{f}^{d},R_{f}^{d},B_{f}^{d}].

It can be learned that using the method shown in this embodiment, the obtained detection period whole body box is obtained by combining the upper body detection box of the to-be-tracked pedestrian and the lower body detection box of the to-be-tracked pedestrian, such that even if the to-be-tracked pedestrian appears in an abnormal posture, for example, the legs are wide open, and therefore an aspect ratio increases, an accurate detection period whole body box can be obtained because in this embodiment, the upper body and the lower body of the to-be-tracked pedestrian can be separately detected, to separately obtain the upper body detection box of the to-be-tracked pedestrian and the lower body detection box of the to-be-tracked pedestrian, in other words, a proportion of the upper body detection box to the lower body detection box in the detection period whole body box varies with a posture of the to-be-tracked pedestrian. It can be learned that a change of a posture of the to-be-tracked pedestrian in a walking process can be accurately captured based on the proportion of the upper body detection box to the lower body detection box that may change, in order to effectively avoid a case in which the to-be-tracked pedestrian cannot be tracked because of a change of a posture of the to-be-tracked pedestrian.

With reference to the fourth implementation of the first aspect of the embodiments of the present disclosure, in a fifth implementation of the first aspect of the embodiments of the present disclosure, after step C, the following steps further need to be performed.

Step D01: Determine a ratio of a width of the detection period whole body box to a height of the detection period whole body box.

For example, the ratio of the width of the detection period whole body box to the height of the detection period whole body box is

$${Ratio}_{wh}^{d} = \frac{{R}_{f}^{d} - {L}_{f}^{d}}{{B}_{f}^{d} - {T}_{f}^{d}} .$$

Step D02: Determine a ratio of a height of the upper body detection box to the height of the detection period whole body box.

For example, the ratio of the height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} .$$

Step D03: Determine the tracking period whole body box.

For example, the tracking period whole body box is determined based on Ratio_{wh}^{d} and Ratioₕₕ^{d}.

Using the method shown in this embodiment, the tracking period whole body box can be determined based on the ratio of the width of the detection period whole body box to the height of the detection period whole body box and the ratio of the height of the upper body detection box to the height of the detection period whole body box. Because the detection period whole body box can accurately capture a change of a posture of the to-be-tracked pedestrian, a change of a posture of the to-be-tracked pedestrian in a walking process can be accurately captured based on the tracking period whole body box obtained using the detection period whole body box, in order to improve accuracy of tracking the to-be-tracked pedestrian using the tracking period whole body box, and effectively avoid a case in which the to-be-tracked pedestrian cannot be tracked because of a change of a posture of the to-be-tracked pedestrian.

With reference to the method according to the second implementation of the first aspect of the embodiments of the present disclosure or the third implementation of the first aspect of the embodiments of the present disclosure, in a sixth implementation of the first aspect of the embodiments of the present disclosure, after step C01, the following steps further need to be performed.

Step C21: Determine an upper-left horizontal coordinate of the detection period whole body box.

For example, if the lower body detection box is not obtained by performing lower body detection in the lower body scanning area, the upper-left horizontal coordinate of the detection period whole body box is determined.

More specifically, the upper-left horizontal coordinate of the detection period whole body box is L_{f}^{d}=Lᵤ^{d}.

Step C22: Determine an upper-left vertical coordinate of the detection period whole body box.

For example, the upper-left vertical coordinate of the detection period whole body box is T_{f}^{d}=Tᵤ^{d}.

Step C23: Determine a lower-right horizontal coordinate of the detection period whole body box.

For example, the lower-right horizontal coordinate of the detection period whole body box is R_{f}^{d}=Rᵤ^{d}.

Step C24: Determine a lower-right vertical coordinate of the detection period whole body box.

For example, the lower-right vertical coordinate of the detection period whole body box is B_{f}^{d}=(Rᵤ^{d}−Lᵤ^{d})*Ratio_{default}+Tᵤ^{d}.

Step C25: Determine that the detection period whole body box is RECT_{f}^{d}=[L_{f}^{d},T_{f}^{d},R_{f}^{d},B_{f}^{d}].

It can be learned that using the method shown in this embodiment, even if the lower body detection box is not obtained in the lower body scanning area, the lower body detection box may be calculated based on the upper body detection box, such that the detection period whole body box can still be obtained when the lower body detection box is not detected, thereby effectively ensuring tracking of the to-be-tracked pedestrian, and avoiding a case in which the to-be-tracked pedestrian cannot be tracked because the lower body of the to-be-tracked pedestrian cannot be detected. In addition, a change of a posture of the to-be-tracked pedestrian in a walking process can be accurately captured, in order to avoid a case in which the to-be-tracked pedestrian cannot be tracked because of a change of a posture of the to-be-tracked pedestrian.

With reference to the sixth implementation of the first aspect of the embodiments of the present disclosure, in a seventh implementation of the first aspect of the embodiments of the present disclosure, the method further includes the following steps.

Step C31: Obtain a preset ratio of a width of the detection period whole body box to a height of the detection period whole body box.

For example, the preset ratio of the width of the detection period whole body box to the height of the detection period whole body box is Ratio_{wh}^{d}.

Step C32: Determine a ratio of a height of the upper body detection box to the height of the detection period whole body box.

For example, the ratio of the height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} .$$

Step C33: Determine the tracking period whole body box based on Ratio_{wh}^{d} and Ratioₕₕ^{d}.

It can be learned that using the method shown in this embodiment, even if the lower body detection box is not obtained in the lower body scanning area, the tracking period whole body box can still be obtained, in order to effectively ensure tracking of the to-be-tracked pedestrian.

With reference to the method according to the fifth implementation of the first aspect of the embodiments of the present disclosure or the seventh implementation of the first aspect of the embodiments of the present disclosure, in an eighth implementation of the first aspect of the embodiments of the present disclosure, the upper body tracking box is RECTᵤ^{t}=[Lᵤ^{t},Tᵤ^{t},Rᵤ^{t},Bᵤ^{t}], where Lᵤ^{t} is an upper-left horizontal coordinate of the upper body tracking box, Tᵤ^{t} is an upper-left vertical coordinate of the upper body tracking box, Rᵤ^{t} is a lower-right horizontal coordinate of the upper body tracking box, and Bᵤ^{t} is a lower-right vertical coordinate of the upper body tracking box.

Step C33 includes the following steps.

Step C331: Determine an upper-left horizontal coordinate of the tracking period whole body box.

For example, if L_{f}^{d}=Lᵤ^{d}, the upper-left horizontal coordinate of the tracking period whole body box is L_{f}^{t}=Lᵤ^{t}.

Step C332: Determine an upper-left vertical coordinate of the tracking period whole body box.

For example, the upper-left vertical coordinate of the tracking period whole body box is T_{f}^{t}=Tᵤ^{t}.

Step C333: Determine a lower-right horizontal coordinate of the tracking period whole body box.

For example, the lower-right horizontal coordinate of the tracking period whole body box is R_{f}^{t}=L_{f}^{t}+W_{f}^{t}.

Step C334: Determine a lower-right vertical coordinate of the tracking period whole body box.

For example, the lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} .$$

More specifically, W_{f}^{t}≤(B_{f}^{t}−T_{f}^{t})*Ratio_{wh}^{d}.

Step C335: Determine the tracking period whole body box.

For example, the tracking period whole body box is RECT_{f}^{t}=[L_{f}^{t},T_{f}^{t},R_{f}^{t},B_{f}^{t}].

Using the method shown in this embodiment, when the upper-left horizontal coordinate L_{f}^{d} of the detection period whole body box is equal to an upper-left horizontal coordinate Lᵤ^{d} of the upper body detection box, the tracking period whole body box can be calculated. In this way, even if a posture of the to-be-tracked pedestrian greatly changes, the tracking period whole body box can still be obtained, in order to avoid a case in which the to-be-tracked pedestrian cannot be tracked, and improve accuracy of tracking the to-be-tracked pedestrian.

With reference to the method according to any one of the first aspect of the embodiments of the present disclosure to the eighth implementation of the first aspect of the embodiments of the present disclosure, in a ninth implementation of the first aspect of the embodiments of the present disclosure, step D includes the following steps.

Step D11: Scatter a plurality of particles using the upper body detection box as a center.

For example, the plurality of particles are scattered using the upper body detection box as a center, and a ratio of a width to a height of any one of the plurality of particles is the same as a ratio of a width of the upper body detection box to the height of the upper body detection box.

If the upper body detection box is determined within the detection period of the to-be-tracked video, the to-be-tracked pedestrian is tracked within the tracking period of the to-be-tracked video. The to-be-tracked pedestrian is in motion in the to-be-tracked video, and locations of the to-be-tracked pedestrian within the detection period and the tracking period are different. Therefore, to track the to-be-tracked pedestrian, a plurality of particles need to be scattered around the upper body detection box of the to-be-tracked pedestrian, to track the to-be-tracked pedestrian.

Step D12: Determine the upper body tracking box.

For example, the upper body tracking box is a particle most similar to the upper body detection box among the plurality of particles.

Using the method shown in this embodiment, the plurality of particles are scattered using the upper body detection box as the center, such that an accurate upper body tracking box can be obtained within the tracking period. In addition, the upper body tracking box is obtained using the upper body detection box, such that different postures of the to-be-tracked pedestrian can be matched, thereby accurately tracking the to-be-tracked pedestrian.

With reference to the eighth implementation of the first aspect of the embodiments of the present disclosure, in a tenth implementation of the first aspect of the embodiments of the present disclosure, step E includes the following steps.

Step E11: Determine the upper-left horizontal coordinate of the tracking period whole body box.

For example, if L_{f}^{d}=Lₗ^{d}, the upper-left horizontal coordinate of the tracking period whole body box is L_{f}^{t}=R_{f}^{t}−W_{f}^{t}.

Step E12: Determine the upper-left vertical coordinate of the tracking period whole body box.

For example, the upper-left vertical coordinate of the tracking period whole body box is T_{f}^{t}=Tᵤ^{t}.

Step E13: Determine the lower-right horizontal coordinate of the tracking period whole body box.

For example, the lower-right horizontal coordinate of the tracking period whole body box is R_{f}^{t}=Rᵤ^{t}.

Step E14: Determine the lower-right vertical coordinate of the tracking period whole body box.

For example, the lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} .$$

More specifically, W_{f}^{t}(B_{f}^{t}−T_{f}^{t})*Ratio_{wh}^{d}.

Step E15: Determine the tracking period whole body box.

For example, the tracking period whole body box is RECT_{f}^{t}=[L_{f}^{t},T_{f}^{t},R_{f}^{t},B_{f}^{t}].

Using the method shown in this embodiment, when the upper-left horizontal coordinate L_{f}^{d} of the detection period whole body box is equal to an upper-left horizontal coordinate Lₗ^{d} of the lower body detection box, the tracking period whole body box can be calculated. In this way, even if a posture of the to-be-tracked pedestrian greatly changes, the tracking period whole body box can still be obtained, in order to avoid a case in which the to-be-tracked pedestrian cannot be tracked, and improve accuracy of tracking the to-be-tracked pedestrian.

With reference to the method according to any one of the first aspect of the embodiments of the present disclosure to the tenth implementation of the first aspect of the embodiments of the present disclosure, in an eleventh implementation of the first aspect of the embodiments of the present disclosure, the method further includes the following steps.

Step E21: Obtain a target image frame sequence of the to-be-tracked video.

The target image frame sequence includes one or more consecutive image frames, and the target image frame sequence is before the detection period.

Step E22: Obtain a background area of the to-be-tracked video based on the target image frame sequence.

For example, in any image frame in the target image frame sequence, a still object is obtained using a static background model, and the still object is determined as the background area of the to-be-tracked video.

Step E23: Obtain a foreground area of any image frame of the to-be-tracked video.

For example, the foreground area of the image frame of the to-be-tracked video is obtained by subtracting the background area from the image frame of the to-be-tracked video within the detection period.

For example, when the background area of the to-be-tracked video is obtained, a difference between any area of the image frame of the to-be-tracked video and the background area is obtained, to obtain a target value. It can be learned that different areas of the image frame of the to-be-tracked video are each corresponding to one target value.

If the target value is greater than or equal to a preset threshold, it indicates that an area that is of the image frame of the to-be-tracked video and that is corresponding to the target value is a motion area.

When the motion area is detected, the motion area is determined as the foreground area of the image frame of the to-be-tracked video.

Step E24: Obtain the to-be-tracked pedestrian.

For example, the to-be-tracked pedestrian is obtained by detecting the foreground area of the image frame of the to-be-tracked video.

With reference to the eleventh implementation of the first aspect of the embodiments of the present disclosure, in a twelfth implementation of the first aspect of the embodiments of the present disclosure, step B includes the following steps.

Step B11: Determine a target image frame.

For example, the target image frame is an image frame in which the to-be-tracked pedestrian appears.

Step B12: Obtain the upper body detection box in a foreground area of the target image frame.

It can be learned that using the method shown in this embodiment, the to-be-tracked pedestrian may be detected and tracked in the foreground area of the image frame of the to-be-tracked video, in other words, both a detection process and a tracking process of the to-be-tracked pedestrian that are shown in this embodiment are executed in the foreground area of the image. Therefore, a quantity of image windows that need to be processed is greatly reduced, in other words, search space for searching for the to-be-tracked pedestrian is reduced, in order to reduce duration required for tracking the to-be-tracked pedestrian, and improve efficiency of tracking the to-be-tracked pedestrian.

A second aspect of the embodiments of the present disclosure provides an electronic device, including a first determining unit, a first obtaining unit, a second obtaining unit, a third obtaining unit, and a fourth obtaining unit.

The first determining unit is configured to determine a detection period and a tracking period of a to-be-tracked video.

The first determining unit shown in this embodiment is configured to perform step A shown in the first aspect of the embodiments of the present disclosure. For an execution process, refer to the first aspect of the embodiments of the present disclosure. Details are not described.

The first obtaining unit is configured to obtain, within the detection period, an upper body detection box of a to-be-tracked pedestrian appearing in the to-be-tracked video.

The first obtaining unit shown in this embodiment is configured to perform step B shown in the first aspect of the embodiments of the present disclosure. For an execution process, refer to the first aspect of the embodiments of the present disclosure. Details are not described.

The second obtaining unit is configured to obtain a detection period whole body box of the to-be-tracked pedestrian based on the upper body detection box.

The second obtaining unit shown in this embodiment is configured to perform step C shown in the first aspect of the embodiments of the present disclosure. For an execution process, refer to the first aspect of the embodiments of the present disclosure. Details are not described.

The third obtaining unit is configured to obtain, within the tracking period, an upper body tracking box of the to-be-tracked pedestrian appearing in the to-be-tracked video.

The third obtaining unit shown in this embodiment is configured to perform step D shown in the first aspect of the embodiments of the present disclosure. For an execution process, refer to the first aspect of the embodiments of the present disclosure. Details are not described.

The fourth obtaining unit is configured to obtain, based on the detection period whole body box, a tracking period whole body box corresponding to the upper body tracking box, where the tracking period whole body box is used to track the to-be-tracked pedestrian.

The fourth obtaining unit shown in this embodiment is configured to perform step E shown in the first aspect of the embodiments of the present disclosure. For an execution process, refer to the first aspect of the embodiments of the present disclosure. Details are not described.

Using the electronic device shown in this embodiment, the obtained detection period whole body box is obtained based on the upper body detection box of the to-be-tracked pedestrian, and an aspect ratio of the detection period whole body box may change. Therefore, even if the to-be-tracked pedestrian appears in an abnormal posture within the detection period, an accurate tracking period whole body box of the to-be-tracked pedestrian can still be obtained using the electronic device shown in this embodiment, such that preparations can still be made to track the to-be-tracked pedestrian when the to-be-tracked pedestrian appears in the abnormal posture.

With reference to the second aspect of the embodiments of the present disclosure, in a first implementation of the second aspect of the embodiments of the present disclosure, the electronic device further includes: the second obtaining unit is configured to: obtain a lower body scanning area based on the upper body detection box; and if a lower body detection box is obtained by performing lower body detection in the lower body scanning area, obtain the detection period whole body box based on the upper body detection box and the lower body detection box.

The second obtaining unit shown in this embodiment is configured to perform step C01 and step C02 shown in the first aspect of the embodiments of the present disclosure. For an execution process, refer to the first aspect of the embodiments of the present disclosure. Details are not described.

Using the electronic device shown in this embodiment, the obtained detection period whole body box is obtained by combining the upper body detection box of the to-be-tracked pedestrian and the lower body detection box of the to-be-tracked pedestrian. It can be learned that an aspect ratio of the obtained detection period whole body box may change. Therefore, even if the to-be-tracked pedestrian appears in an abnormal posture within the detection period, for example, in a posture that the legs of the to-be-tracked pedestrian are wide open, and therefore a proportion of the upper body to the lower body of the to-be-tracked pedestrian changes, an accurate detection period whole body box of the to-be-tracked pedestrian can still be obtained by combining the obtained upper body detection box and the obtained lower body detection box, in order to prepare to track the to-be-tracked pedestrian.

With reference to the first implementation of the second aspect of the embodiments of the present disclosure, in a second implementation of the second aspect of the embodiments of the present disclosure, the upper body detection box is RECTᵤ^{d}=[Lᵤ^{d},Tᵤ^{d},Rᵤ^{d},Bᵤ^{d}], where Lᵤ^{d} is an upper-left horizontal coordinate of the upper body detection box, Tᵤ^{d} is an upper-left vertical coordinate of the upper body detection box, Rᵤ^{d} is a lower-right horizontal coordinate of the upper body detection box, and Bᵤ^{d} is a lower-right vertical coordinate of the upper body detection box; and when obtaining the lower body scanning area based on the upper body detection box, the second obtaining unit is configured to: determine a first parameter, where the first parameter is

$${B}_{f}^{estimate} = {B}_{u}^{d} - ( {B}_{u}^{d} - {T}_{u}^{d} ) * ( 1 - \frac{1}{{Ratio}_{default}} ) ,$$

where Ratio_{default} is a preset ratio; determine a second parameter, where the second parameter is Wᵤ^{d}=Rᵤ^{d}−Lᵤ^{d}; determine a third parameter, where the third parameter is H_{f}^{estimate}=the first parameter B_{f}^{estimate}−Tᵤ^{d}; and determine the lower body scanning area based on the first parameter, the second parameter, and the third parameter.

The second obtaining unit shown in this embodiment is configured to perform step C011, step C012, step C013, and step C014 shown in the first aspect of the embodiments of the present disclosure. For an execution process, refer to the first aspect of the embodiments of the present disclosure. Details are not described.

It can be learned that, when obtaining the first parameter, the second parameter, and the third parameter, the electronic device shown in this embodiment may determine the lower body scanning area, such that the lower body detection box of the to-be-tracked pedestrian is detected in the obtained lower body scanning area, thereby improving accuracy and efficiency of obtaining the lower body detection box of the to-be-tracked pedestrian, and improving efficiency of tracking the to-be-tracked pedestrian.

With reference to the second implementation of the second aspect of the embodiments of the present disclosure, in a third implementation of the second aspect of the embodiments of the present disclosure, when obtaining the lower body scanning area based on the upper body detection box, the second obtaining unit is configured to determine the lower body scanning area based on the first parameter, the second parameter, and the third parameter, where the lower body scanning area is ScanArea=[L^{s}, T^{s}, R^{s}, B^{s}], L^{s} is an upper-left horizontal coordinate of the lower body scanning area, T^{s} is an upper-left vertical coordinate of the lower body scanning area, R^{s} is a lower-right horizontal coordinate of the lower body scanning area, and B^{s} is a lower-right vertical coordinate of the lower body scanning area, where L^{s}=max{1, Lᵤ^{d}−Wᵤ^{d}/paral1}, T^{s}=max{1, Tᵤ^{d}+H_{f}^{estimate}/paral2}, R^{s}=min{imgW−1, Rᵤ^{d}+Wᵤ^{d}/paral2} and B^{s}=min{imgH−1, B_{f}^{estimate}+H_{f}^{estimate}Wᵤ^{d}/paral3}; and paral1, paral2, and paral3 are preset values, imgW is a width of any image frame of the to-be-tracked video within the detection period, and imgH is a height of any image frame of the to-be-tracked video within the detection period.

The second obtaining unit shown in this embodiment is configured to perform step C014 shown in the first aspect of the embodiments of the present disclosure. For an execution process, refer to the first aspect of the embodiments of the present disclosure. Details are not described.

Using the electronic device shown in this embodiment, the lower body detection box of the to-be-tracked pedestrian can be detected in the obtained lower body scanning area, in order to improve accuracy and efficiency of obtaining the lower body detection box of the to-be-tracked pedestrian, and improve efficiency of tracking the to-be-tracked pedestrian. In addition, in an obtaining process, different settings of the lower body scanning area may be implemented through different settings of the parameters (paral1, paral2, and paral3), in order to achieve high applicability of the electronic device shown in this embodiment. In this way, in different application scenarios, different orientations of the lower body detection box may be implemented based on different settings of the parameters, in order to improve accuracy of detecting the to-be-tracked pedestrian.

With reference to the method according to any one of the first implementation of the second aspect of the embodiments of the present disclosure to the third implementation of the second aspect of the embodiments of the present disclosure, in a fourth implementation of the second aspect of the embodiments of the present disclosure, the lower body detection box is RECTₗ^{d}=[Lₗ^{d},Tₗ^{d},Rₗ^{d},Bₗ^{d}], where Lₗ^{d} is an upper-left horizontal coordinate of the lower body detection box, Tₗ^{d} is an upper-left vertical coordinate of the lower body detection box, Rₗ^{d} is a lower-right horizontal coordinate of the lower body detection box, and Bₗ^{d} is a lower-right vertical coordinate of the lower body detection box; and when obtaining the detection period whole body box of the to-be-tracked pedestrian based on the upper body detection box, the second obtaining unit is configured to: determine an upper-left horizontal coordinate of the detection period whole body box, where the upper-left horizontal coordinate of the detection period whole body box is L_{f}^{d}=min (Lᵤ^{d},Lₗ^{d}); determine that an upper-left vertical coordinate of the detection period whole body box is T_{f}^{d}=Tᵤ^{d}; determine that a lower-right horizontal coordinate of the detection period whole body box is R_{f}^{d}=max(Rᵤ^{d},Rₗ^{d}); determine that a lower-right vertical coordinate of the detection period whole body box is B_{f}^{d}=Bₗ^{d}; and determine that the detection period whole body box is RECT_{f}^{d}=[L_{f}^{d},T_{f}^{d},R_{f}^{d},B_{f}^{d}].

The second obtaining unit shown in this embodiment is configured to perform step C11, step C12, step C13, step C14, and step C15 shown in the first aspect of the embodiments of the present disclosure. For an execution process, refer to the first aspect of the embodiments of the present disclosure. Details are not described.

It can be learned that using the electronic device shown in this embodiment, the obtained detection period whole body box is obtained by combining the upper body detection box of the to-be-tracked pedestrian and the lower body detection box of the to-be-tracked pedestrian, such that even if the to-be-tracked pedestrian appears in an abnormal posture, for example, the legs are wide open, and therefore an aspect ratio increases, an accurate detection period whole body box can be obtained because in this embodiment, the upper body and the lower body of the to-be-tracked pedestrian can be separately detected, to separately obtain the upper body detection box of the to-be-tracked pedestrian and the lower body detection box of the to-be-tracked pedestrian, in other words, a proportion of the upper body detection box to the lower body detection box in the detection period whole body box varies with a posture of the to-be-tracked pedestrian. It can be learned that a change of a posture of the to-be-tracked pedestrian in a walking process can be accurately captured based on the proportion of the upper body detection box to the lower body detection box that may change, in order to effectively avoid a case in which the to-be-tracked pedestrian cannot be tracked because of a change of a posture of the to-be-tracked pedestrian.

With reference to the fourth implementation of the second aspect of the embodiments of the present disclosure, in a fifth implementation of the second aspect of the embodiments of the present disclosure, the fourth obtaining unit is configured to: determine that a ratio of a width of the detection period whole body box to a height of the detection period whole body box is

$${Ratio}_{wh}^{d} = \frac{{R}_{f}^{d} - {L}_{f}^{d}}{{B}_{f}^{d} - {T}_{f}^{d}} ;$$

determine that a ratio of a height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} ;$$

and determine the tracking period whole body box based on Ratio_{wh}^{d} and Ratioₕₕ^{d}.

The fourth obtaining unit shown in this embodiment is configured to perform step D01, step D02, and step D03 shown in the first aspect of the embodiments of the present disclosure. For an execution process, refer to the first aspect of the embodiments of the present disclosure. Details are not described.

Using the electronic device shown in this embodiment, the tracking period whole body box can be determined based on the ratio of the width of the detection period whole body box to the height of the detection period whole body box and the ratio of the height of the upper body detection box to the height of the detection period whole body box. Because the detection period whole body box can accurately capture a change of a posture of the to-be-tracked pedestrian, a change of a posture of the to-be-tracked pedestrian in a walking process can be accurately captured based on the tracking period whole body box obtained using the detection period whole body box, in order to improve accuracy of tracking the to-be-tracked pedestrian using the tracking period whole body box, and effectively avoid a case in which the to-be-tracked pedestrian cannot be tracked because of a change of a posture of the to-be-tracked pedestrian.

With reference to the electronic device according to the second implementation of the second aspect of the embodiments of the present disclosure or the third implementation of the second aspect of the embodiments of the present disclosure, in a sixth implementation of the second aspect of the embodiments of the present disclosure, when obtaining the detection period whole body box of the to-be-tracked pedestrian based on the upper body detection box, the second obtaining unit is configured to: if the lower body detection box is not obtained by performing lower body detection in the lower body scanning area, determine an upper-left horizontal coordinate of the detection period whole body box, where the upper-left horizontal coordinate of the detection period whole body box is L_{f}^{d}=Lᵤ^{d}; determine that an upper-left vertical coordinate of the detection period whole body box is T_{f}^{d}=Tᵤ^{d}; determine that a lower-right horizontal coordinate of the detection period whole body box is R_{f}^{d}=Rᵤ^{d}; determine that a lower-right vertical coordinate of the detection period whole body box is B_{f}^{d}=(Rᵤ^{d}−Lᵤ^{d})*Ratio_{default}+Tᵤ^{d}; and determine that the detection period whole body box is RECT_{f}^{d}=[L_{f}^{d},T_{f}^{d},R_{f}^{d},B_{f}^{d}].

The second obtaining unit shown in this embodiment is configured to perform step C21, step C22, step C23, C24 and C25 shown in the first aspect of the embodiments of the present disclosure. For an execution process, refer to the first aspect of the embodiments of the present disclosure. Details are not described.

It can be learned that using the electronic device shown in this embodiment, even if the lower body detection box is not obtained in the lower body scanning area, the lower body detection box may be calculated based on the upper body detection box, such that the detection period whole body box can still be obtained when the lower body detection box is not detected, thereby effectively ensuring tracking of the to-be-tracked pedestrian, and avoiding a case in which the to-be-tracked pedestrian cannot be tracked because the lower body of the to-be-tracked pedestrian cannot be detected. In addition, a change of a posture of the to-be-tracked pedestrian in a walking process can be accurately captured, in order to avoid a case in which the to-be-tracked pedestrian cannot be tracked because of a change of a posture of the to-be-tracked pedestrian.

With reference to the sixth implementation of the second aspect of the embodiments of the present disclosure, in a seventh implementation of the second aspect of the embodiments of the present disclosure, the fourth obtaining unit is configured to: obtain a preset ratio Ratio_{wh}^{d} of a width of the detection period whole body box to a height of the detection period whole body box; determine that a ratio of a height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} ;$$

and determine the tracking period whole body box based on Ratio_{wh}^{d} and Ratioₕₕ^{d}.

The fourth obtaining unit shown in this embodiment is configured to perform step C31, step C32, and step C33 shown in the first aspect of the embodiments of the present disclosure. For an execution process, refer to the first aspect of the embodiments of the present disclosure. Details are not described.

It can be learned that using the electronic device shown in this embodiment, even if the lower body detection box is not obtained in the lower body scanning area, the tracking period whole body box can still be obtained, in order to effectively ensure tracking of the to-be-tracked pedestrian.

With reference to the electronic device according to the fifth implementation of the second aspect of the embodiments of the present disclosure or the seventh implementation of the second aspect of the embodiments of the present disclosure, in an eighth implementation of the second aspect of the embodiments of the present disclosure, the upper body tracking box is RECTᵤ^{t}=[Lᵤ^{t},Tᵤ^{t},Rᵤ^{t},Bᵤ^{t}], where Lᵤ^{t} is an upper-left horizontal coordinate of the upper body tracking box, Tᵤ^{t} is an upper-left vertical coordinate of the upper body tracking box, Rᵤ^{t} is a lower-right horizontal coordinate of the upper body tracking box, and Bᵤ^{t} is a lower-right vertical coordinate of the upper body tracking box; and when determining the tracking period whole body box based on Ratio_{wh}^{d} and Ratioₕₕ^{d}, the fourth obtaining unit is configured to: determine an upper-left horizontal coordinate of the tracking period whole body box, where if L_{f}^{d}=Lᵤ^{d}, the upper-left horizontal coordinate of the tracking period whole body box is L_{f}^{t}=Lᵤ^{t}; determine that an upper-left vertical coordinate of the tracking period whole body box is T_{f}^{t}=Tᵤ^{t}; determine that a lower-right horizontal coordinate of the tracking period whole body box is R_{f}^{t}=L_{f}^{t}+W_{f}^{t}; determine that a lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}; and determine that the tracking period whole body box is RECT_{f}^{t}=[L_{f}^{t},T_{f}^{t},R_{f}^{t},B_{f}^{t}].

The fourth obtaining unit shown in this embodiment is configured to perform step C331, step C332, step C333, step C334, and step C335 shown in the first aspect of the embodiments of the present disclosure. For an execution process, refer to the first aspect of the embodiments of the present disclosure. Details are not described.

Using the electronic device shown in this embodiment, when the upper-left horizontal coordinate L_{f}^{d} of the detection period whole body box is equal to an upper-left horizontal coordinate Lᵤ^{d} of the upper body detection box, the tracking period whole body box can be calculated. In this way, even if a posture of the to-be-tracked pedestrian greatly changes, the tracking period whole body box can still be obtained, in order to avoid a case in which the to-be-tracked pedestrian cannot be tracked, and improve accuracy of tracking the to-be-tracked pedestrian.

With reference to the electronic device according to any one of the second aspect of the embodiments of the present disclosure to the eighth implementation of the second aspect of the embodiments of the present disclosure, in a ninth implementation of the second aspect of the embodiments of the present disclosure, the third obtaining unit is configured to: scatter a plurality of particles using the upper body detection box as a center, where a ratio of a width to a height of any one of the plurality of particles is the same as a ratio of a width of the upper body detection box to the height of the upper body detection box; and determine the upper body tracking box, where the upper body tracking box is a particle most similar to the upper body detection box among the plurality of particles.

The third obtaining unit shown in this embodiment is configured to perform step D11 and step D12 shown in the first aspect of the embodiments of the present disclosure. For an execution process, refer to the first aspect of the embodiments of the present disclosure. Details are not described.

Using the electronic device shown in this embodiment, the plurality of particles are scattered using the upper body detection box as the center, such that an accurate upper body tracking box can be obtained within the tracking period. In addition, the upper body tracking box is obtained using the upper body detection box, such that different postures of the to-be-tracked pedestrian can be matched, thereby accurately tracking the to-be-tracked pedestrian.

With reference to the eighth implementation of the second aspect of the embodiments of the present disclosure, in a tenth implementation of the second aspect of the embodiments of the present disclosure, the fourth obtaining unit is configured to: determine the upper-left horizontal coordinate of the tracking period whole body box, where if L_{f}^{d}=Lₗ^{d}, the upper-left horizontal coordinate of the tracking period whole body box is L_{f}^{t}=R_{f}^{t}−W_{f}^{t}; determine that the upper-left vertical coordinate of the tracking period whole body box is T_{f}^{t}=Tᵤ^{t}; determine that the lower-right horizontal coordinate of the tracking period whole body box is R_{f}^{t}=Rᵤ^{t}; determine that the lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}; and determine that the tracking period whole body box is RECT_{f}^{t}=[L_{f}^{t},T_{f}^{t},R_{f}^{t},B_{f}^{t}].

The fourth obtaining unit shown in this embodiment is configured to perform step E11, step E12, step E13, step E14, and step E15 shown in the first aspect of the embodiments of the present disclosure. For an execution process, refer to the first aspect of the embodiments of the present disclosure. Details are not described.

Using the electronic device shown in this embodiment, when the upper-left horizontal coordinate L_{f}^{d} of the detection period whole body box is equal to an upper-left horizontal coordinate Lₗ^{d} of the lower body detection box, the tracking period whole body box can be calculated. In this way, even if a posture of the to-be-tracked pedestrian greatly changes, the tracking period whole body box can still be obtained, in order to avoid a case in which the to-be-tracked pedestrian cannot be tracked, and improve accuracy of tracking the to-be-tracked pedestrian.

With reference to the electronic device according to any one of the second aspect of the embodiments of the present disclosure to the tenth implementation of the second aspect of the embodiments of the present disclosure, in an eleventh implementation of the second aspect of the embodiments of the present disclosure, the electronic device further includes a fifth obtaining unit, a sixth obtaining unit, a seventh obtaining unit, and an eighth obtaining unit.

The fifth obtaining unit is configured to obtain a target image frame sequence of the to-be-tracked video, where the target image frame sequence includes one or more consecutive image frames, and the target image frame sequence is before the detection period.

The fifth obtaining unit shown in this embodiment is configured to perform step E21 shown in the first aspect of the embodiments of the present disclosure. For an execution process, refer to the first aspect of the embodiments of the present disclosure. Details are not described.

The sixth obtaining unit is configured to obtain a background area of the to-be-tracked video based on the target image frame sequence.

The sixth obtaining unit shown in this embodiment is configured to perform step E22 shown in the first aspect of the embodiments of the present disclosure. For an execution process, refer to the first aspect of the embodiments of the present disclosure. Details are not described.

The seventh obtaining unit is configured to obtain a foreground area of any image frame of the to-be-tracked video by subtracting the background area from the image frame of the to-be-tracked video within the detection period.

The seventh obtaining unit shown in this embodiment is configured to perform step E23 shown in the first aspect of the embodiments of the present disclosure. For an execution process, refer to the first aspect of the embodiments of the present disclosure. Details are not described.

The eighth obtaining unit is configured to obtain the to-be-tracked pedestrian by detecting the foreground area of the image frame of the to-be-tracked video.

The eighth obtaining unit shown in this embodiment is configured to perform step E24 shown in the first aspect of the embodiments of the present disclosure. For an execution process, refer to the first aspect of the embodiments of the present disclosure. Details are not described.

With reference to the eleventh implementation of the second aspect of the embodiments of the present disclosure, in a twelfth implementation of the second aspect of the embodiments of the present disclosure, the first obtaining unit is configured to: determine a target image frame, where the target image frame is an image frame in which the to-be-tracked pedestrian appears; and obtain the upper body detection box in a foreground area of the target image frame.

The first obtaining unit shown in this embodiment is configured to perform step B11 and step B12 shown in the first aspect of the embodiments of the present disclosure. For an execution process, refer to the first aspect of the embodiments of the present disclosure. Details are not described.

It can be learned that using the electronic device shown in this embodiment, the to-be-tracked pedestrian may be detected and tracked in the foreground area of the image frame of the to-be-tracked video, in other words, both a detection process and a tracking process of the to-be-tracked pedestrian that are shown in this embodiment are executed in the foreground area of the image. Therefore, a quantity of image windows that need to be processed is greatly reduced, in other words, search space for searching for the to-be-tracked pedestrian is reduced, in order to reduce duration required for tracking the to-be-tracked pedestrian, and improve efficiency of tracking the to-be-tracked pedestrian.

The embodiments of the present disclosure provide the pedestrian tracking method and the electronic device. According to the method, the upper body detection box of the to-be-tracked pedestrian appearing in the to-be-tracked video can be obtained within the detection period; the detection period whole body box of the to-be-tracked pedestrian is obtained based on the upper body detection box; and the tracking period whole body box corresponding to an upper body tracking box is obtained within the tracking period based on the detection period whole body box. It can be learned that the to-be-tracked pedestrian may be tracked using the tracking period whole body box. An aspect ratio of the detection period whole body box may change. Therefore, even if the to-be-tracked pedestrian appears in an abnormal posture within the detection period, an accurate tracking period whole body box of the to-be-tracked pedestrian can still be obtained using the method shown in the embodiments, such that preparations can still be made to track the to-be-tracked pedestrian when the to-be-tracked pedestrian appears in the abnormal posture.

### DESCRIPTION OF DRAWINGS

FIG. 1 is a schematic structural diagram of an embodiment of an electronic device according to the present disclosure;

FIG. 2 is a schematic structural diagram of an embodiment of a processor according to the present disclosure;

FIG. 3A and FIG. 3B are flowcharts of an embodiment of a pedestrian tracking method according to the present disclosure;

FIG. 4 is a schematic application diagram of an embodiment of a pedestrian tracking method according to the present disclosure;

FIG. 5 is a schematic application diagram of another embodiment of a pedestrian tracking method according to the present disclosure;

FIG. 6 is a schematic application diagram of another embodiment of a pedestrian tracking method according to the present disclosure;

FIG. 7 is a schematic application diagram of another embodiment of a pedestrian tracking method according to the present disclosure;

FIG. 8 is a schematic application diagram of another embodiment of a pedestrian tracking method according to the present disclosure;

FIG. 9A and FIG. 9B are flowcharts of an embodiment of a pedestrian query method according to the present disclosure;

FIG. 10 is a schematic diagram of execution steps of an embodiment of a pedestrian query method according to the present disclosure; and

FIG. 11 is a schematic structural diagram of another embodiment of an electronic device according to the present disclosure.

### DESCRIPTION OF EMBODIMENTS

The embodiments of the present disclosure provide a pedestrian tracking method. To better understand the pedestrian tracking method shown in the embodiments of the present disclosure, the following first describes in detail a structure of an electronic device that can perform the method shown in the embodiments of the present disclosure.

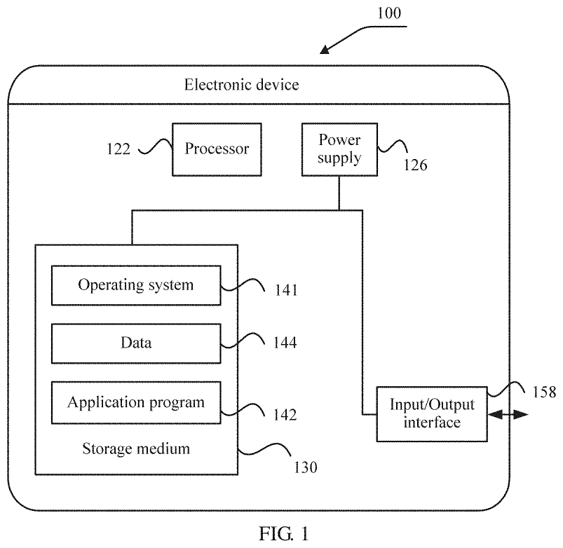

The structure of the electronic device shown in the embodiments is described below in detail with reference to FIG. 1. FIG. 1 is a schematic structural diagram of an embodiment of an electronic device according to the present disclosure.

The electronic device 100 may greatly vary with configuration or performance, and may include one or more processors 122.

The processor 122 is not limited in this embodiment, provided that the processor 122 can have computing and image processing capabilities to perform the pedestrian tracking method shown in the embodiments. Optionally, the processor 122 shown in this embodiment may be a central processing unit (CPU).

One or more storage media 130 (for example, one or more massive storage devices) are configured to store an application program 142 or data 144.

The storage medium 130 may be a transient storage medium or a persistent storage medium. The program stored in the storage medium 130 may include one or more modules (which are not marked in the figure), and each module may include a series of instruction operations in the electronic device.

Further, the processor 122 may be configured to: communicate with the storage medium 130, and perform a series of instruction operations in the storage medium 130 in the electronic device 100.

The electronic device 100 may further include one or more power supplies 126, one or more input/output interfaces 158, and/or one or more operating systems 141 such as Windows Server™, Mac OS X™, Unix™, Linux™, and FreeBSD™.

In an implementation of the present disclosure, the electronic device may be any device having an image processing capability and a computing capability, and includes, but is not limited to, a server, a camera, a mobile computer, a tablet computer, and the like.

If the electronic device shown in this embodiment performs the pedestrian tracking method shown in the embodiments, the input/output interface 158 shown in this embodiment may be configured to receive massive surveillance videos, and the input/output interface 158 can display a detection process, a pedestrian tracking result, and the like. The processor 122 is configured to perform pedestrian detection and execute a pedestrian tracking algorithm. The storage medium 130 is configured to store an operating system, an application program, and the like, and the storage medium 130 can store an intermediate result in a pedestrian tracking process, and the like. It can be learned that in a process of performing the method shown in the embodiments, the electronic device shown in this embodiment can find a target pedestrian that needs to be tracked from the massive surveillance videos, and provide information such as a time and a place at which the target pedestrian appears in the surveillance video.

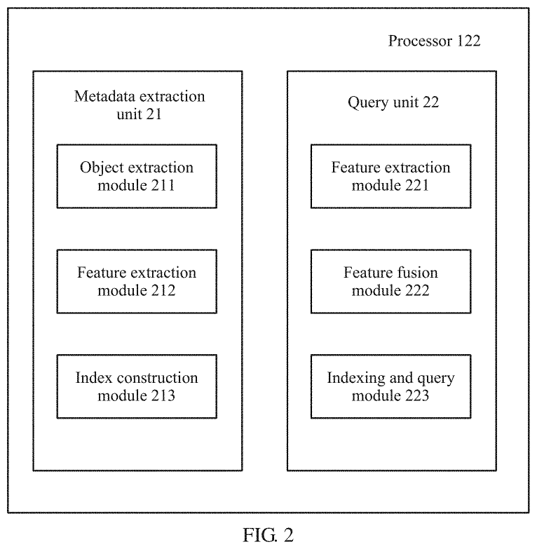

A structure of the processor 122 configured to implement the pedestrian tracking method shown in the embodiments is described below in detail with reference to FIG. 2.

, the processor 122 includes a metadata extraction unit 21 and a query unit 22.

More specifically, the metadata extraction unit 21 includes an object extraction module 211, a feature extraction module 212, and an index construction module 213.

More specifically, the query unit 22 includes a feature extraction module 221, a feature fusion module 222, and an indexing and query module 223.

In this embodiment, the processor 122 can execute the program stored in the storage medium 130, to implement a function of any module in any unit included in the processor 122 shown in FIG. 2.

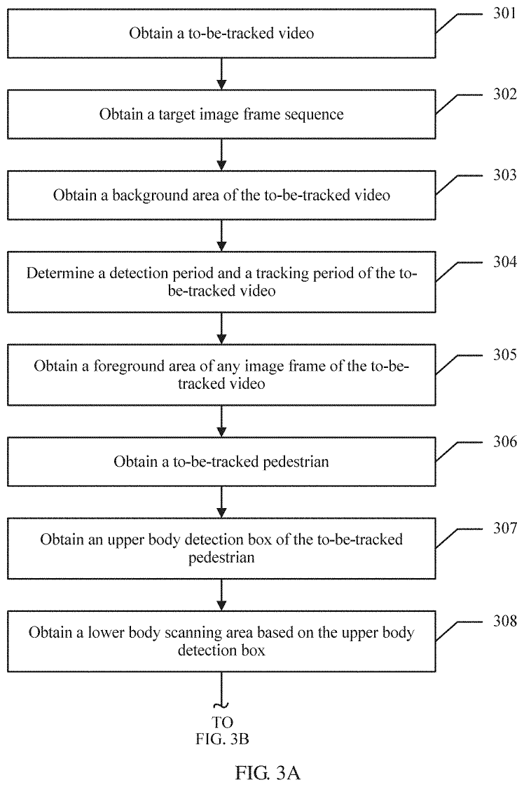

Based on the electronic device shown in FIG. 1 and FIG. 2, an execution procedure of the pedestrian tracking method shown in the embodiments is described below in detail with reference to FIG. 3A and FIG. 3B.

FIG. 3A and FIG. 3B are flowcharts of an embodiment of a pedestrian tracking method according to the present disclosure.

It should be first noted that an execution body of the pedestrian tracking method shown in this embodiment is the electronic device, and may be one or more modules of the processor 122, for example, the object extraction module 211.

The pedestrian tracking method shown in this embodiment includes the following steps.

Step 301: Obtain a to-be-tracked video.

For example, the object extraction module 211 included in the processor 122 shown in this embodiment is configured to obtain the to-be-tracked video.

Optionally, if the electronic device shown in this embodiment includes no camera, for example, the electronic device is a server, the electronic device shown in this embodiment communicates with a plurality of cameras using the input/output interface 158. The camera is configured to shoot a to-be-tracked pedestrian to generate a to-be-tracked video. Correspondingly, the electronic device receives, using the input/output interface 158, the to-be-tracked video from the camera, and further, the object extraction module 211 of the processor 122 obtains the to-be-tracked video received by the input/output interface 158.

Optionally, if the electronic device shown in this embodiment includes a camera, for example, the electronic device is a video camera, the object extraction module 211 of the processor 122 of the electronic device obtains the to-be-tracked video shot by the camera of the electronic device.

In an application, the to-be-tracked video shown in this embodiment is usually massive videos.

It should be noted that the manner of obtaining the to-be-tracked video in this embodiment is an optional example, and does not constitute a limitation, provided that the object extraction module 211 can obtain the to-be-tracked video used for pedestrian tracking.

Step 302: Obtain a target image frame sequence.

For example, the object extraction module 211 shown in this embodiment obtains the target image frame sequence.

More specifically, after obtaining the to-be-tracked video, the object extraction module 211 shown in this embodiment determines the target image frame sequence in the to-be-tracked video.

The target image frame sequence is the first M image frames of the to-be-tracked video, and a specific value of M is not limited in this embodiment, provided that M is a positive integer greater than 1.

The target image frame sequence includes one or more consecutive image frames.

Step 303: Obtain a background area of the to-be-tracked video.

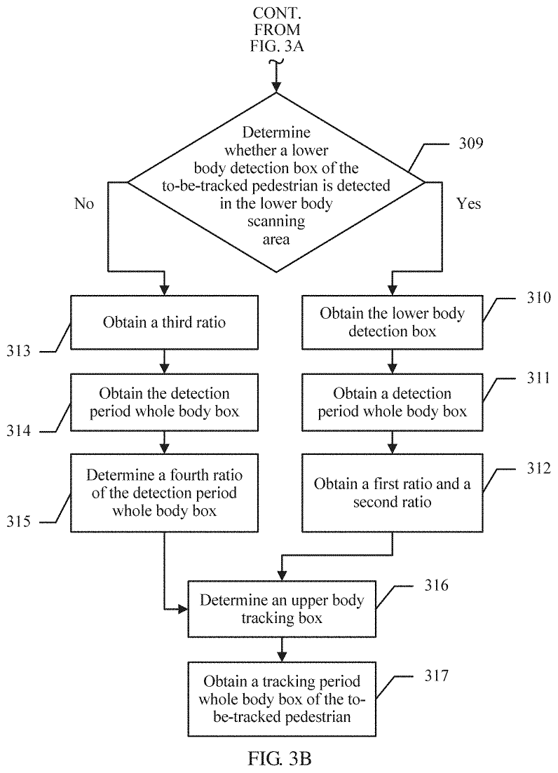

For example, the object extraction module 211 shown in this embodiment learns the target image frame sequence of the to-be-tracked video, to obtain the background area of the to-be-tracked video. For the background area of the to-be-tracked video shown in this embodiment, refer to FIG. 4.

Optionally, the object extraction module 211 may obtain the background area of the to-be-tracked video in the following manner. The object extraction module 211 obtains a still object from any image frame of the target image frame sequence using a static background model, and determines the still object as the background area of the to-be-tracked video.

It should be noted that the description of obtaining the background area of the to-be-tracked video in this embodiment is an optional example, and does not constitute a limitation. For example, the object extraction module 211 may alternatively use a frame difference method, an optical flow field method, or the like, provided that the object extraction module 211 can obtain the background area.

It should be further noted that step 303 shown in this embodiment is an optional step.

Step 304: Determine a detection period and a tracking period of the to-be-tracked video.

For example, the object extraction module 211 determines the detection period T1 and the tracking period T2.

Optionally, the detection period T1 shown in this embodiment is included in the tracking period T2, and duration of the detection period T1 is less than duration of the tracking period T2.

For example, the duration of the tracking period T2 may be 10 minutes, the duration of the detection period T1 is 2 seconds, and the first 2 seconds within 10 minutes of the duration of the tracking period T2 are the detection period T1.

Optionally, the detection period T1 shown in this embodiment may not be included in the tracking period T2, the detection period T1 may be before the tracking period T2, and duration of the detection period T1 may be less than duration of the tracking period T2.

For example, the duration of the detection period T1 is 2 seconds, the duration of the tracking period T2 may be 10 minutes, and the tracking period T2 is further executed after the detection period T1.

It should be noted that the descriptions of the duration of the detection period T1 and the duration of the tracking period T2 in this embodiment are optional examples, and do not constitute any limitation.

In this embodiment, an example in which the detection period T1 is included in the tracking period T2 is used for description.

More specifically, a start frame of the detection period T1 shown in this embodiment is a t^{th} frame of the to-be-tracked video, and t is greater than M. It can be learned that the target image frame sequence in this embodiment is before the detection period T1.

Step 305: Obtain a foreground area of any image frame of the to-be-tracked video.

For example, the object extraction module 211 shown in this embodiment obtains the foreground area of the image frame of the to-be-tracked video by subtracting the background area from the image frame of the to-be-tracked video within the detection period.

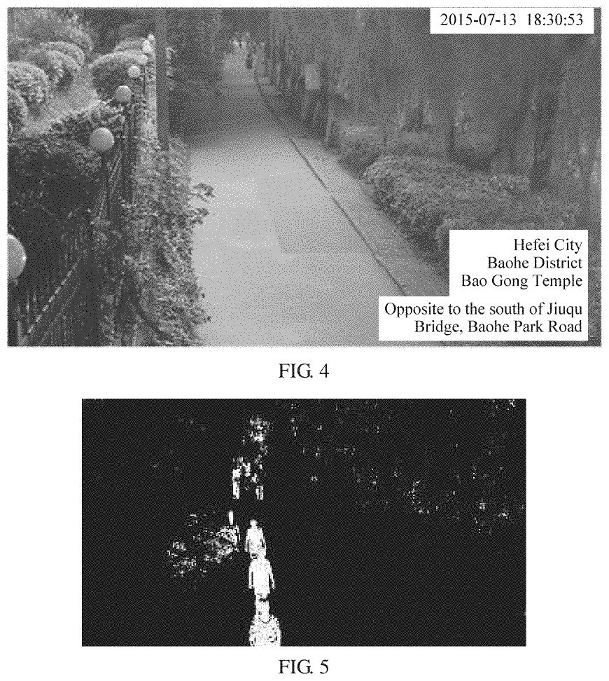

FIG. 5 shows the obtained foreground area of the image frame of the to-be-tracked video shown in this embodiment. White pixels shown in FIG. 5 are the foreground area of the image frame of the to-be-tracked video.

For example, when obtaining the background area of the to-be-tracked video, the object extraction module 211 shown in this embodiment obtains a difference between any area of the image frame of the to-be-tracked video and the background area, to obtain a target value. It can be learned that different areas of the image frame of the to-be-tracked video each correspond to one target value.

If the target value is greater than or equal to a preset threshold, it indicates that an area that is of the image frame of the to-be-tracked video and that corresponds to the target value is a motion area.

The preset threshold shown in this embodiment is set in advance, and a value of the preset threshold is not limited in this embodiment, provided that a motion area of the image frame of the to-be-tracked video can be determined based on the preset threshold.

When the motion area is detected, the motion area is determined as the foreground area of the image frame of the to-be-tracked video.

Step 306: Obtain a to-be-tracked pedestrian.

The object extraction module 211 shown in this embodiment obtains the to-be-tracked pedestrian by detecting the foreground area of the image frame of the to-be-tracked video.

A specific quantity of to-be-tracked pedestrians detected by the object extraction module 211 is not limited in this embodiment.

Step 307: Obtain an upper body detection box of the to-be-tracked pedestrian.

To obtain the upper body detection box of the to-be-tracked pedestrian shown in this embodiment, the object extraction module 211 shown in this embodiment first determines a target image frame.

For example, the target image frame shown in this embodiment is an image frame in which the to-be-tracked pedestrian appears.

Optionally, if the to-be-tracked pedestrian shown in this embodiment is a pedestrian appearing in any image frame within the detection period T1 of the to-be-tracked video, the object extraction module 211 may determine that an image frame in which the to-be-tracked pedestrian appears is the target image frame. In other words, the target image frame is an image frame in which the to-be-tracked pedestrian appears within the detection period of the to-be-tracked video.

Optionally, if the to-be-tracked pedestrian shown in this embodiment is a pedestrian appearing in consecutive image frames within the detection period T1 of the to-be-tracked video, the object extraction module 211 may determine that a last image frame in which the to-be-tracked pedestrian appears and that is in the consecutive image frames of the to-be-tracked video in which the to-be-tracked pedestrian continuously appears is the target image frame. Alternatively, the object extraction module 211 may determine that a random image frame in which the to-be-tracked pedestrian appears and that is in the consecutive image frames of the to-be-tracked video in which the to-be-tracked pedestrian continuously appears is the target image frame. This is not specifically limited in this embodiment.

Optionally, if the to-be-tracked pedestrian shown in this embodiment is a pedestrian appearing in image frames within the detection period T1 of the to-be-tracked video at intervals, the object extraction module 211 may determine that a last image frame in which the to-be-tracked pedestrian appears and that is in the image frames of the to-be-tracked video in which the to-be-tracked pedestrian appears at intervals is the target image frame. Alternatively, or the object extraction module 211 may determine that a random image frame in which the to-be-tracked pedestrian appears and that is in the image frames of the to-be-tracked video in which the to-be-tracked pedestrian appears at intervals is the target image frame. This is not specifically limited in this embodiment.

It should be noted that the foregoing description of how to determine the target image frame is an optional example, and does not constitute a limitation, provided that the to-be-tracked pedestrian appears in the target image frame.

When determining the target image frame, the object extraction module 211 may obtain the upper body detection box in the target image frame.

A first detector may be disposed on the object extraction module 211 shown in this embodiment, and the first detector is configured to detect the upper body detection box.

For example, the first detector of the object extraction module 211 obtains the upper body detection box in a foreground area of the target image frame.

The object extraction module 211 shown in this embodiment can detect the to-be-tracked pedestrian in the foreground area of the target image frame. In other words, in a process of detecting the to-be-tracked pedestrian, the object extraction module 211 does not need to detect the background area, in order to greatly reduce a time required for pedestrian detection while pedestrian detection accuracy is improved.

The following describes how the object extraction module 211 obtains the upper body detection box of the to-be-tracked pedestrian in the foreground area of the target image frame.

The object extraction module 211 shown in this embodiment obtains, within the detection period, the upper body detection box of the to-be-tracked pedestrian appearing in the to-be-tracked video.

For example, the upper body detection box shown in this embodiment is RECTᵤ^{d}=[Lᵤ^{d},Tᵤ^{d},Rᵤ^{d},Bᵤ^{d}].

Lᵤ^{d} is an upper-left horizontal coordinate of the upper body detection box, Tᵤ^{d} is an upper-left vertical coordinate of the upper body detection box, Rᵤ^{d} is a lower-right horizontal coordinate of the upper body detection box, and Bᵤ^{d} is a lower-right vertical coordinate of the upper body detection box.

When detecting the to-be-tracked pedestrian, the object extraction module 211 shown in this embodiment may obtain Lᵤ^{d}, Tᵤ^{d}, Rᵤ^{d}, and Bᵤ^{d}.

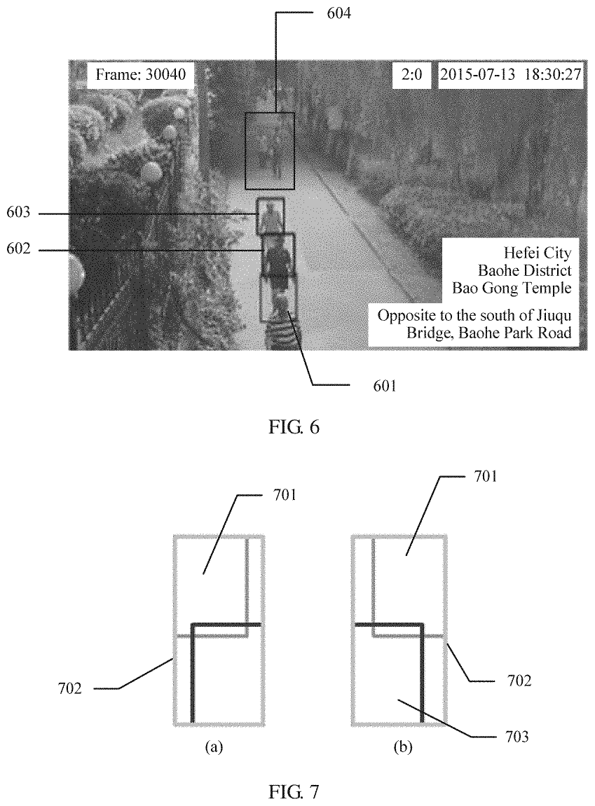

An example in which the target image frame determined by the object extraction module 211 is shown in FIG. 6. Using the foregoing method shown in this embodiment, to-be-tracked pedestrians appearing in the target image frame can be detected, to obtain an upper body detection box of each to-be-tracked pedestrian.

In a detection process shown in FIG. 6, because a pedestrian 601 in the target image frame appears on an edge of the target image frame, and the whole body of the pedestrian 601 is not completely displayed, the object extraction module 211 shown in this embodiment cannot obtain an upper body detection box of the pedestrian 601.

If both the whole body of a pedestrian 602 and the whole body of a pedestrian 603 in the target image frame clearly appear in the target image frame, the object extraction module 211 may obtain an upper body detection box of the pedestrian 602 and an upper body detection box of the pedestrian 603.

If each pedestrian in an area 604 in the target image frame is not clearly displayed, the object extraction module 211 shown in this embodiment cannot obtain an upper body detection box of each pedestrian in the area 604.

It can be learned that the object extraction module 211 shown in this embodiment detects only an upper body detection box of a to-be-tracked pedestrian displayed in the target image frame.

For example, the to-be-tracked pedestrian is a pedestrian completely displayed in the target image frame. In other words, both the upper body and the lower body of the to-be-tracked pedestrian are completely displayed in the target image frame.

More specifically, the to-be-tracked pedestrian is a pedestrian whose area displayed in the target image frame is greater than or equal to a preset threshold of the object extraction module 211. In other words, if the to-be-tracked pedestrian whose area displayed in the target image frame is greater than or equal to the preset threshold, it indicates that the to-be-tracked pedestrian is clearly displayed in the target image frame. When the to-be-tracked pedestrian in the target image frame is less than the preset threshold, the object extraction module 211 cannot detect the to-be-tracked pedestrian.

Step 308: Obtain a lower body scanning area based on the upper body detection box.

In this embodiment, after the object extraction module 211 obtains the upper body detection box of the to-be-tracked pedestrian, the object extraction module 211 may obtain the lower body scanning area of the to-be-tracked pedestrian based on the upper body detection box of the to-be-tracked pedestrian.

To obtain the lower body scanning area of the to-be-tracked pedestrian, the object extraction module 211 needs to obtain a first parameter, a second parameter, and a third parameter.

The first parameter is

$${B}_{f}^{estimate} = {B}_{u}^{d} - ( {B}_{u}^{d} - {T}_{u}^{d} ) * ( 1 - \frac{1}{{Ratio}_{default}} ) ,$$

where Ratio_{default} is a preset ratio.

Optionally, Ratio_{default} in this embodiment is pre-stored by the object extraction module 211 in the memory medium 130, and Ratio_{default} may be preset by the object extraction module 211 based on an aspect ratio of a human body detection box (as shown in BACKGROUND). For example, if it is pre-determined that the aspect ratio of the human body detection box is 3:7, the object extraction module 211 may set Ratio_{default} to 3/7, and store Ratio_{default} in the memory medium 130, such that in a process of performing this step, the object extraction module 211 can extract Ratio_{default} from the memory medium 130 to calculate the first parameter B_{f}^{estimate}.

The second parameter is Wᵤ^{d}=Rᵤ^{d}−Lᵤ^{d}, and the third parameter is H_{f}^{estimate}=the first parameter B_{f}^{estimate}−Tᵤ^{d}.

When the object extraction module 211 obtains the first parameter, the second parameter, and the third parameter, the object extraction module 211 may determine the lower body scanning area.

The lower body scanning area is where is ScanArea=[L^{s},T^{s},R^{s},B^{s}], where L^{s} is an upper-left horizontal coordinate of the lower body scanning area, T^{s} is an upper-left vertical coordinate of the lower body scanning area, R^{s} is a lower-right horizontal coordinate of the lower body scanning area, and B^{s} is a lower-right vertical coordinate of the lower body scanning area.

For example, L^{s}=max{1, Lᵤ^{d}−Wᵤ^{d}/paral1}, T^{s}=max{1, Tᵤ^{d}+H_{f}^{estimate}/paral2}, R^{s}=min{imgW−1, Rᵤ^{d}+Wᵤ^{d}/paral2}, and B^{s}=min{imgH−1, B_{f}^{estimate}+H_{f}^{estimate}Wᵤ^{d}/paral3}.

More specifically, paral1, paral2, and paral3 are preset values.

Specific values of paral1, paral2, and paral3 are not limited in this embodiment, and paral1, paral2, and paral3 may be empirical values. Alternatively, operating staff may implement different settings of the lower body scanning area through different settings of paral1, paral2 and paral3.

imgW is a width of any image frame of the to-be-tracked video within the detection period, and imgH is a height of any image frame of the to-be-tracked video within the detection period.

Step 309: Determine whether a lower body detection box of the to-be-tracked pedestrian is detected in the lower body scanning area. If the lower body detection box of the to-be-tracked pedestrian is detected in the lower body scanning area, perform step 310. Otherwise, if the lower body detection box of the to-be-tracked pedestrian is not detected in the lower body scanning area, perform step 313.

For example, the object extraction module 211 shown in this embodiment performs lower body detection in the lower body scanning area, to determine whether the lower body detection box of the to-be-tracked pedestrian can be detected.

Step 310: Obtain the lower body detection box.

For example, a lower body detector may be disposed on the object extraction module 211.

More specifically, when performing lower body detection in the lower body scanning area, to determine that the lower body detection box of the to-be-tracked pedestrian can be obtained, the lower body detector of the object extraction module 211 shown in this embodiment determines that the lower body detection box is RECTₗ^{d}=[Lₗ^{d},Tₗ^{d},Rₗ^{d},Bₗ^{d}], where Lₗ^{d} is an upper-left horizontal coordinate of the lower body detection box, Tₗ^{d} is an upper-left vertical coordinate of the lower body detection box, Rₗ^{d} is a lower-right horizontal coordinate of the lower body detection box, and Bₗ^{d} is a lower-right vertical coordinate of the lower body detection box.

Step 311: Obtain a detection period whole body box.

For example, the object extraction module 211 obtains the detection period whole body box based on the upper body detection box and the lower body detection box.

More specifically, the object extraction module 211 shown in this embodiment combines the upper body detection box and the lower body detection box, to obtain the detection period whole body box.

The detection period whole body box is RECT_{f}^{d}=[L_{f}^{d},T_{f}^{d},R_{f}^{d},B_{f}^{d}].

An upper-left horizontal coordinate of the detection period whole body box is L_{f}^{d}=min(Lᵤ^{d},Lₗ^{d}), an upper-left vertical coordinate of the detection period whole body box is T_{f}^{d}=Tᵤ^{d}, a lower-right horizontal coordinate of the detection period whole body box is R_{f}^{d}=max (Rᵤ^{d}, Rₗ^{d}), and a lower-right vertical coordinate of the detection period whole body box is B_{f}^{d}=Bₗ^{d}.

Step 312: Obtain a first ratio and a second ratio.

For example, after obtaining the detection period whole body box, the object extraction module 211 shown in this embodiment may determine the first ratio of the detection period whole body box.

The first ratio is a ratio of a width of the detection period whole body box to a height of the detection period whole body box, and the first ratio is

$${Ratio}_{wh}^{d} = \frac{{R}_{f}^{d} - {L}_{f}^{d}}{{B}_{f}^{d} - {T}_{f}^{d}} .$$

The object extraction module 211 shown in this embodiment determines the second ratio of the detection period whole body box.

For example, the second ratio is a ratio of a height of the upper body detection box to the height of the detection period whole body box, and the second ratio is

$${Ratio}_{hh}^{d} = \frac{{B}_{u}^{d} - {T}_{u}^{d}}{{B}_{f}^{d} - {T}_{f}^{d}} .$$

Step 313: Obtain a third ratio.

In this embodiment, if the object extraction module 211 does not obtain the lower body detection box by performing lower body detection in the lower body scanning area, the object extraction module 211 obtains the third ratio. The third ratio is a preset ratio Ratio_{wh}^{d} of a width of the detection period whole body box to a height of the detection period whole body box.

Step 314: Obtain the detection period whole body box.

In this embodiment, when the object extraction module 211 does not obtain the lower body detection box by performing lower body detection in the lower body scanning area, the object extraction module 211 obtains the detection period whole body box RECT_{f}^{d}=[L_{f}^{d},T_{f}^{d},R_{f}^{d},B_{f}^{d}].

An upper-left horizontal coordinate of the detection period whole body box is L_{f}^{d}=Lᵤ^{d}, an upper-left vertical coordinate of the detection period whole body box is T_{f}^{d}=Tᵤ^{d}, a lower-right horizontal coordinate of the detection period whole body box is R_{f}^{d}=Rᵤ^{d}, and a lower-right vertical coordinate of the detection period whole body box is B_{f}^{d}=(Rᵤ^{d}−Lᵤ^{d})*Ratio_{default}+Tᵤ^{d}.

Step 315: Determine a fourth ratio of the detection period whole body box.

The object extraction module 211 shown in this embodiment determines that the fourth ratio is a ratio of a height of the upper body detection box to the height of the detection period whole body box.

The fourth ratio is

$${Ratio}_{hh}^{d} = \frac{{B}_{u}^{d} - {T}_{u}^{d}}{{B}_{f}^{d} - {T}_{f}^{d}} .$$

After step 312 or step 315 is performed, step 316 shown in this embodiment continues to be performed.

Step 316: Determine an upper body tracking box.

In this embodiment, the object extraction module 211 initializes the detection period whole body box obtained within the detection period T1 as a tracking target, such that the object extraction module 211 can track, within the tracking period T2, the to-be-tracked pedestrian serving as the tracking target.

It should be noted that in this embodiment, there may be at least one to-be-tracked pedestrian determined in the foregoing step. If there are a plurality of to-be-tracked pedestrians, each of the to-be-tracked pedestrians needs to be used as the tracking target for tracking.

For example, if the to-be-tracked pedestrians determined in the foregoing step are a pedestrian A, a pedestrian B, a pedestrian C, and a pedestrian D, the pedestrian A needs to be set as the tracking target to perform subsequent steps for tracking, the pedestrian B needs to be set as the tracking target to perform subsequent steps for tracking, and so forth. In other words, each to-be-tracked pedestrian in the to-be-tracked video needs to be set as the tracking target to perform subsequent steps for tracking.

When tracking the to-be-tracked pedestrian, the object extraction module 211 first determines the upper body detection box. The object extraction module 211 separately performs normal division sampling using the upper body detection box as a center. In other words, the object extraction module 211 scatters a plurality of particles around the upper body detection box, and determines the upper body tracking box in the plurality of particles.

For better understanding, the following provides a description with reference to an application scenario.

If the object extraction module 211 determines the upper body detection box in an N1 frame within the detection period T1 of the to-be-tracked video, the object extraction module 211 tracks the to-be-tracked pedestrian in an N2 frame within the tracking period T2 of the to-be-tracked video. The N2 frame is any frame within the tracking period T2 of the to-be-tracked video.

The to-be-tracked pedestrian is in motion in the to-be-tracked video, and a location of the to-be-tracked pedestrian in the N1 frame is different from a location of the to-be-tracked pedestrian in the N2 frame. Therefore, in order for the object extraction module 211 to track the to-be-tracked pedestrian, the object extraction module 211 needs to scatter a plurality of particles around the upper body detection box of the to-be-tracked pedestrian, to track the to-be-tracked pedestrian.

For example, a fifth ratio of any one of the plurality of particles is the same as a sixth ratio of the upper body detection box, the fifth ratio is a ratio of a width to a height of any one of the plurality of particles, and the sixth ratio is a ratio of a width of the upper body detection box to a height of the upper body detection box.

It can be learned that using the method shown in this embodiment, any particle scattered by the object extraction module 211 around the upper body detection box is a rectangular box having a same ratio of a width to a height as the upper body detection box.

The object extraction module 211 determines the upper body tracking box in the plurality of particles.

For example, the object extraction module 211 determines that a particle most similar to the upper body detection box among the plurality of particles is the upper body tracking box.

The upper body tracking box is RECTᵤ^{t}=[Lᵤ^{t},Tᵤ^{t},Rᵤ^{t},Bᵤ^{t}], where Lᵤ^{t} is an upper-left horizontal coordinate of the upper body tracking box, Tᵤ^{t} is an upper-left vertical coordinate of the upper body tracking box, Rᵤ^{t} is a lower-right horizontal coordinate of the upper body tracking box, and Bᵤ^{t} is a lower-right vertical coordinate of the upper body tracking box.

Step 317: Obtain a tracking period whole body box of the to-be-tracked pedestrian.

In this embodiment, the object extraction module 211 obtains, based on the detection period whole body box, the tracking period whole body box corresponding to the upper body tracking box.

The tracking period whole body box is used to track the to-be-tracked pedestrian.

The following describes in detail how the object extraction module 211 obtains the tracking period whole body box.

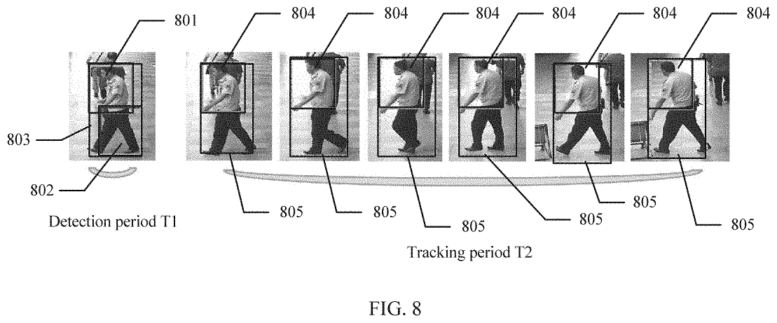

After the object extraction module 211 obtains the detection period whole body box and the upper body tracking box, as shown in FIG. 7, the object extraction module 211 determines whether an upper-left horizontal coordinate of the upper body detection box 701 is equal to an upper-left horizontal coordinate t of the detection period whole body box 702.

As shown in (a) in FIG. 7, if the object extraction module 211 determines that L_{f}^{d}=Lᵤ^{d}, the object extraction module 211 determines that an upper-left horizontal coordinate of the tracking period whole body box is L_{f}^{t}=Lᵤ^{t}; the object extraction module 211 determines that an upper-left vertical coordinate of the tracking period whole body box is T_{f}^{t}=Tᵤ^{t}; the object extraction module 211 determines that a lower-right horizontal coordinate of the tracking period whole body box is R_{f}^{t}=L_{f}^{t}+W_{f}^{t}; and the object extraction module 211 determines that a lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}.

For a description of Ratio_{wh}^{d}, refer to the foregoing step. Details are not described in this step.

The object extraction module 211 shown in this embodiment may determine that the tracking period whole body box is RECT_{f}^{t}=[L_{f}^{t},T_{f}^{t},R_{f}^{t},B_{f}^{t}].

After the object extraction module 211 obtains the detection period whole body box and the upper body tracking box, as shown in FIG. 7, the object extraction module 211 determines whether the upper-left horizontal coordinate L_{f}^{d} of the detection period whole body box 702 is equal to an upper-left horizontal coordinate Lₗ^{d} of the lower body detection box 703.

As shown in (b) in FIG. 7, if the upper-left horizontal coordinate L_{f}^{d} of the detection period whole body box 702 is equal to the upper-left horizontal coordinate Lₗ^{d} of the lower body detection box 703, the object extraction module 211 determines that the upper-left horizontal coordinate of the tracking period whole body box is of L_{f}^{t}=Lᵤ^{t}; the object extraction module 211 determines that the upper-left vertical coordinate of the tracking period whole body box is T_{f}^{t}=Tᵤ^{t}; the object extraction module 211 determines that the lower-right horizontal coordinate of the tracking period whole body box is R_{f}^{t}=Rᵤ^{t}; the object extraction module 211 determines that the lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}; and the object extraction module 212 determines that the tracking period whole body box is RECT_{f}^{t}=[L_{f}^{t},T_{f}^{t},R_{f}^{t}B_{f}^{t}].

For descriptions of Ratio_{wh}^{d} and Ratioₕₕ^{d}, refer to the foregoing step. Details are not described in this step.

Using the method shown in this embodiment, the to-be-tracked pedestrian can be tracked in the to-be-tracked video within the tracking period T2 using the tracking period whole body box.

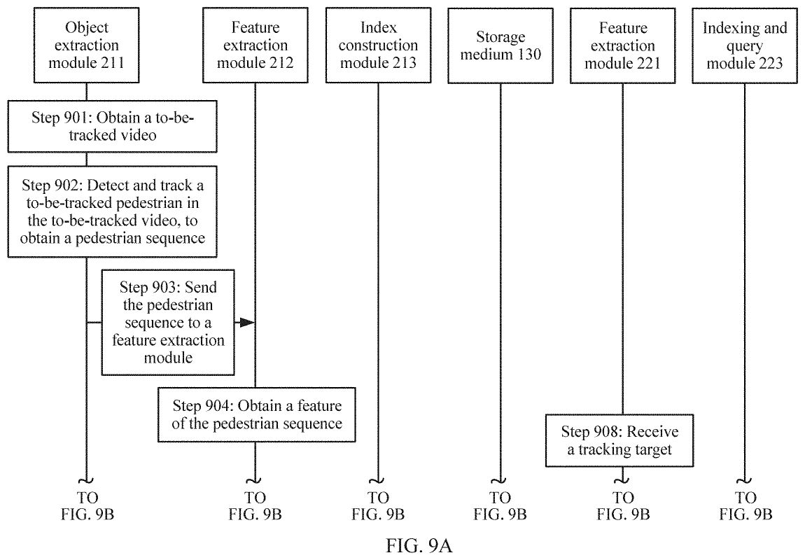

To better understand the method shown in this embodiment of the present disclosure, beneficial effects of the pedestrian tracking method shown in this embodiment are described below in detail with reference to an application scenario shown in FIG. 8.

The object extraction module 211 shown in this embodiment obtains, within the detection period T1, an upper body detection box 801 of the to-be-tracked pedestrian that is shown in FIG. 8. For a process of obtaining the upper body detection box 801, refer to the foregoing step. Details are not described in this application scenario.

The object extraction module 211 obtains, within the detection period T1, a lower body detection box 802 of the to-be-tracked pedestrian that is shown in FIG. 8. For a process of obtaining the lower body detection box 802, refer to the foregoing embodiment. Details are not described in this embodiment.

The object extraction module 211 obtains, within the detection period T1, a detection period whole body box 803 shown in FIG. 8. For a process of obtaining the detection period whole body box 803, refer to the foregoing embodiment. Details are not described in this embodiment.

After obtaining the detection period whole body box 803, the object extraction module 211 may obtain a ratio Ratio_{wh}^{d} of a width of the detection period whole body box 803 to a height of the detection period whole body box 803, and a ratio Ratioₕₕ^{d} of a height of the upper body detection box 801 to the height of the detection period whole body box 803.

Using the method shown in this embodiment, in a process of obtaining the detection period whole body box 803, the detection period whole body box 803 obtained by the object extraction module 211 is obtained by combining the upper body detection box 801 of the to-be-tracked pedestrian and the lower body detection box 802 of the to-be-tracked pedestrian. It can be learned that an aspect ratio of the detection period whole body box 803 obtained by the object extraction module 211 may change. Therefore, even if the to-be-tracked pedestrian appears in an abnormal posture within the detection period T1, for example, in a posture that the legs of the to-be-tracked pedestrian are wide open, and therefore a proportion of the upper body to the lower body of the to-be-tracked pedestrian changes, the object extraction module 211 can still obtain an accurate detection period whole body box 803 of the to-be-tracked pedestrian by combining the obtained upper body detection box and the obtained lower body detection box.

The object extraction module 211 can accurately capture a change of a posture of the to-be-tracked pedestrian based on the aspect ratio of the detection period whole body box 803 in this embodiment that may change, such that the detection period whole body box 803 can accurately capture the change of the posture of the to-be-tracked pedestrian. It can be learned that an accurate detection period whole body box 803 can still be obtained regardless of the change of the posture of the to-be-tracked pedestrian.

The object extraction module 211 may obtain an upper body tracking box 804 and a tracking period whole body box 805 within the detection period T2. For an obtaining process, refer to the foregoing step. Details are not described in this embodiment.

The object extraction module 211 shown in this embodiment can still use Ratio_{wh}^{d} and Ratioₕₕ^{d} within the tracking period T2, to obtain a more accurate tracking period whole body box 805 based on Ratio_{wh}^{d} and Ratioₕₕ^{d} that may change. In this way, even if a posture of the to-be-tracked pedestrian changes, the to-be-tracked pedestrian can still be accurately tracked within the tracking period T2.

In a process of tracking a pedestrian, step 304 shown in this embodiment to step 317 shown in this embodiment may be performed for a plurality of times, in order to more accurately track the to-be-tracked pedestrian. For example, after the object extraction module 211 executes the tracking period T2 once, the object extraction module 211 may repeatedly execute the tracking period T2 for a plurality of times within a subsequent time. A quantity of times of executing the tracking period T2 is not limited in this embodiment.

Because the object extraction module 211 shown in this embodiment may execute the tracking period T2 a plurality of times, the object extraction module 211 may update specific values of Ratio_{wh}^{d} and Ratioₕₕ^{d} for a plurality of times based on a detection result, in order to obtain a more accurate tracking period whole body box within the tracking period T2, thereby accurately tracking the pedestrian.

Using the method shown in this embodiment, the to-be-tracked pedestrian may be detected and tracked in the foreground area of the image frame of the to-be-tracked video. In other words, both a detection process and a tracking process of the to-be-tracked pedestrian that are shown in this embodiment are executed in the foreground area of the image. Therefore, a quantity of image windows that need to be processed is greatly reduced. In other words, search space for searching for the to-be-tracked pedestrian by the electronic device is reduced, in order to reduce duration required for tracking the to-be-tracked pedestrian, and improve efficiency of tracking the to-be-tracked pedestrian by the electronic device.

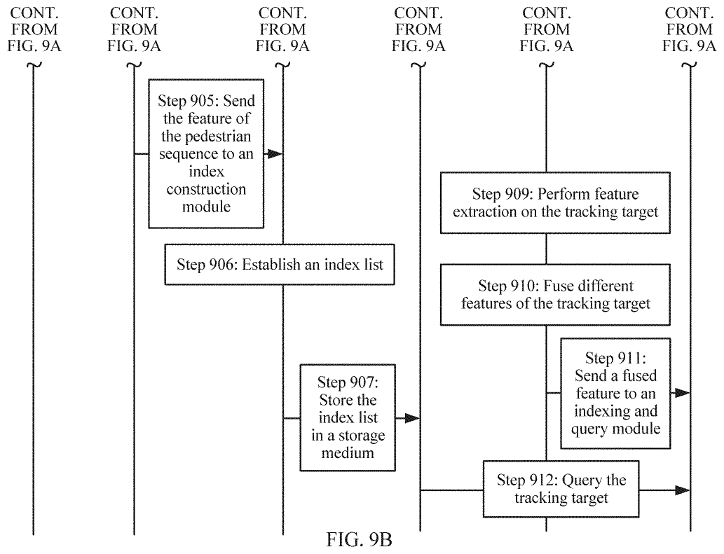

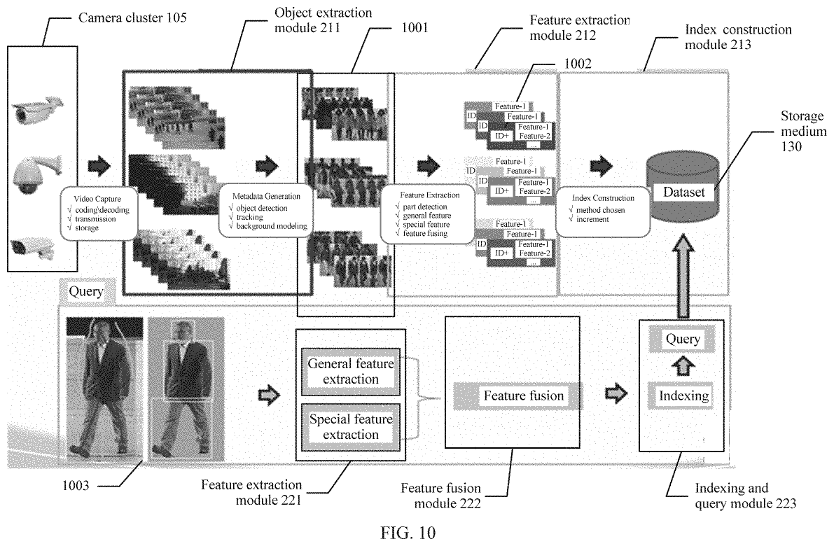

Based on the electronic device shown in FIG. 1 and FIG. 2, the following describes in detail a pedestrian query method according to an embodiment with reference to FIG. 9A, FIG. 9B, and FIG. 10.

FIG. 9A and FIG. 9B are flowcharts of an embodiment of a pedestrian query method according to the present disclosure. FIG. 10 is a schematic diagram of execution steps of an embodiment of a pedestrian tracking method according to the present disclosure.

It should be first noted that a description of each execution body of the pedestrian query method shown in this embodiment is an optional example, and does not constitute a limitation, In other words, the execution body of each step shown in this embodiment may be any module of the processor 122 shown in FIG. 2, or the execution body of each step shown in this embodiment may be a module that is not shown in FIG. 2. This is not specifically limited in this embodiment, provided that the electronic device can perform the pedestrian query method shown in this embodiment.

Step 901: Obtain a to-be-tracked video.

For an execution process of step 901 shown in this embodiment, refer to step 301 shown in FIG. 3A and FIG. 3B. The execution process is not described in this embodiment.

Step 902: Detect and track a to-be-tracked pedestrian in the to-be-tracked video, to obtain a pedestrian sequence.

The object extraction module 211 shown in this embodiment is configured to detect and track the to-be-tracked pedestrian in the to-be-tracked video. For an execution process, refer to step 302 to step 317 shown in the foregoing embodiment. Details are not described in this embodiment.

For example, if the object extraction module 211 shown in this embodiment obtains a plurality of to-be-tracked pedestrians in the foregoing step, the object extraction module 211 obtains the pedestrian sequence through summarizing in the foregoing step.

The pedestrian sequence obtained by the object extraction module 211 includes a plurality of sub-sequences, and any one of the plurality of sub-sequences is a target sub-sequence. The target sub-sequence corresponds to a target to-be-tracked pedestrian, and the target to-be-tracked pedestrian corresponds to one of the plurality of to-be-tracked pedestrians determined in the foregoing step.

The target sub-sequence shown in this embodiment includes a plurality of image frames, and any one of the plurality of image frames includes the target to-be-tracked pedestrian.

Any image frame included in the target sub-sequence has the tracking period whole body box that corresponds to the target to-be-tracked pedestrian and that is shown in the foregoing step.

It can be learned that the pedestrian sequence shown in this embodiment includes the plurality of sub-sequences, and any one of the plurality of sub-sequences includes the plurality of image frames. An image frame included in any sub-sequence displays a tracking period whole body box that is of the to-be-tracked pedestrian and that corresponds to the sub-sequence.

As shown in FIG. 10, an example in which the electronic device includes no camera is used for description in this embodiment. The electronic device shown in this embodiment can communicate with a camera cluster 105. The camera cluster 105 includes a plurality of cameras, and each camera can shoot a to-be-tracked pedestrian to generate a to-be-tracked video, such that the electronic device can receive the to-be-tracked video from the camera.

The object extraction module 211 may create different sub-sequences 1001 for different target to-be-tracked pedestrians, and the sub-sequence 1001 includes a plurality of image frames that correspond to the target to-be-tracked pedestrian and in which the target to-be-tracked pedestrian appears.

Step 903: Send the pedestrian sequence to a feature extraction module 212.

In this embodiment, the object extraction module 211 sends the pedestrian sequence to the feature extraction module 212.

Step 904: Obtain a feature of the pedestrian sequence.

The feature extraction module 212 shown in this embodiment uses the pedestrian sequence as an input to extract the feature of the pedestrian sequence.

For example, the feature extraction module 212 may analyze the pedestrian sequence, to check whether each pixel in any image frame included in the pedestrian sequence represents a feature, in order to extract the feature of the pedestrian sequence.

For example, the feature of the pedestrian sequence is a set of features of all target to-be-tracked pedestrians included in the pedestrian sequence.

For example, if the pedestrian sequence includes five to-be-tracked pedestrians: A, B, C, D, and E, the feature extraction module 212 may perform feature extraction on an image frame of the pedestrian A to obtain a feature set of a target to-be-tracked pedestrian corresponding to the pedestrian A, and perform feature extraction on an image frame of the pedestrian B to obtain a feature set of a target to-be-tracked pedestrian corresponding to the pedestrian B, until feature extraction of all pedestrians in the pedestrian sequence is completed.

As shown in FIG. 10, the feature set 1002 created by the feature extraction module 212 includes a target identifier ID corresponding to a target to-be-tracked pedestrian and a plurality of image features corresponding to the target to-be-tracked pedestrian.

An example is used in which the target to-be-tracked pedestrian is pedestrian A, and the feature set 1002 corresponding to the target to-be-tracked pedestrian A includes a target identifier ID corresponding to the target to-be-tracked pedestrian A and a plurality of image features corresponding to the target to-be-tracked pedestrian A.

It can be learned that the feature extraction module 212 shown in this embodiment can create a correspondence between each of different target to-be-tracked pedestrians and each of different target identifier IDs, and a correspondence between each of different target identifier IDs and each of a plurality of image features.

Step 905: Send the feature of the pedestrian sequence to an index construction module 213.

The feature extraction module 212 shown in this embodiment can send the obtained feature of the pedestrian sequence to the index construction module 213.

Step 906: Establish an index list.

After receiving the feature of the pedestrian sequence, the index construction module 213 shown in this embodiment establishes the index list. A correspondence included in the index list is the correspondence between each of different target to-be-tracked pedestrians and each of different target identifier IDs, and the correspondence between each of different target identifier IDs and each of a plurality of image features. In addition, the index construction module 213 shown in this embodiment can further create, using the index list, different target identifier IDs and any information such as a time and a place at which corresponding target to-be-tracked pedestrians appear in the to-be-tracked video.

Step 907: Store the index list in a storage medium 130.

After creating the index list, the index construction module 213 shown in this embodiment stores the index list in the storage medium 130.

In step 901 to step 907 shown in this embodiment, different pedestrians can be classified in massive to-be-tracked videos, to facilitate subsequent tracking target query.

When a tracking target needs to be queried, the following steps may be performed.

Step 908: Receive a tracking target.

As shown in this embodiment, image-based image search can be implemented. In other words, an image in which the tracking target appears may be input into the feature extraction module 221 during query.

FIG. 10 is used as an example. To query the tracking target, an image 1003 in which the tracking target appears may be input into the feature extraction module 221.

Step 909: Perform feature extraction on the tracking target.

For example, the feature extraction module 221 shown in this embodiment can analyze an image in which the tracking target appears, to obtain a feature of the tracking target. Using the method shown in this embodiment, a plurality of features corresponding to the tracking target can be obtained.

Step 910: Fuse different features of the tracking target.

In this embodiment, the feature fusion module 222 can fuse the different features of the tracking target.

As shown in FIG. 10, the feature fusion module 222 can fuse the different features of the tracking target to obtain a fused feature. It can be learned that the fused feature shown in this embodiment corresponds to the tracking target.

Step 911: Send the fused feature to the indexing and query module.

Step 912: Query the tracking target.

The indexing and query module 223 shown in this embodiment queries the tracking target based on the fused feature corresponding to the tracking target.

For example, the indexing and query module 223 matches the fused feature and the index list stored in the storage medium 130, to find a target identifier ID corresponding to the fused feature, such that the indexing and query module 223 can obtain, based on the index list, any information such as a time and a place at which a pedestrian corresponding to the target identifier ID appears in the to-be-tracked video. In this embodiment, the pedestrian corresponding to the target identifier ID is the tracking target.

It can be learned that using the method shown in this embodiment, only an image in which the tracking target appears needs to be received, to obtain information such as a time and a place at which the tracking target appears in massive videos.

For descriptions of beneficial effects achieved by detecting and tracking the to-be-tracked pedestrian in the method shown in this embodiment, refer to the foregoing embodiment. Details are not described in this embodiment.

Using the method shown in this embodiment, in a process of searching for a tracking target, the tracking target can be quickly and accurately located in massive to-be-tracked videos, in order to quickly obtain information such as a time and a place at which the tracking target appears in massive to-be-tracked videos.

An application scenario of the method shown in this embodiment is not limited. For example, the method may be applied to performing image-based image searches in a safe city, in order to quickly obtain information related to a tracking target. The method may be further applied to mobilization trail generation and analysis, population statistics collection, pedestrian warning in vehicle-assisted driving, and the like. For example, as long as a video that includes a pedestrian needs to be intelligently analyzed, pedestrian detection and tracking may be performed using this embodiment of the present disclosure, in order to extract information such as a location and a trail of the pedestrian.

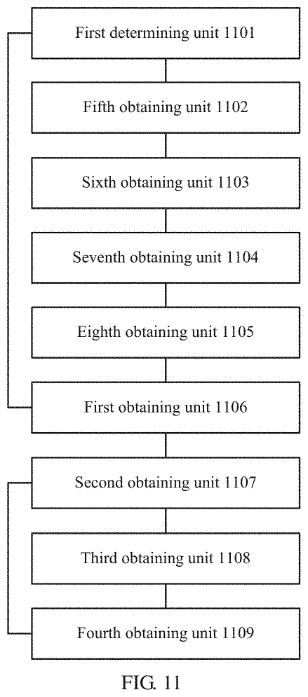

FIG. 1 describes a structure of the electronic device from a perspective of physical hardware. The following describes a structure of the electronic device with reference to FIG. 11 from a perspective of executing a procedure of the pedestrian tracking method shown in the foregoing embodiments, such that the electronic device shown in this embodiment can perform the pedestrian tracking method shown in the foregoing embodiments.

The electronic device includes a first determining unit 1101, a fifth obtaining unit 1102, a sixth obtaining unit 1103, a seventh obtaining unit 1104, an eighth obtaining unit 1105, a first obtaining unit 1106, a second obtaining unit 1107, a third obtaining unit 1108, and a fourth obtaining unit 1109.

The first determining unit 1101 is configured to determine a detection period and a tracking period of a to-be-tracked video.

The fifth obtaining unit 1102 is configured to obtain a target image frame sequence of the to-be-tracked video, where the target image frame sequence includes one or more consecutive image frames, and the target image frame sequence is before the detection period.

The sixth obtaining unit 1103 is configured to obtain a background area of the to-be-tracked video based on the target image frame sequence.

The seventh obtaining unit 1104 is configured to obtain a foreground area of any image frame of the to-be-tracked video by subtracting the background area from the image frame of the to-be-tracked video within the detection period.

The eighth obtaining unit 1105 is configured to obtain the to-be-tracked pedestrian by detecting the foreground area of the image frame of the to-be-tracked video.

Optionally, the fifth obtaining unit 1102 to the eighth obtaining unit 1105 shown in this embodiment are optional units. In an application, the electronic device may not include the fifth obtaining unit 1102 to the eighth obtaining unit 1105 shown in this embodiment.

The first obtaining unit 1106 is configured to obtain, within the detection period, an upper body detection box of a to-be-tracked pedestrian appearing in the to-be-tracked video, where the upper body detection box is RECTᵤ^{d}=[Lᵤ^{d},Tᵤ^{d},Rᵤ^{d},Bᵤ^{d}], where Lᵤ^{d} is an upper-left horizontal coordinate of the upper body detection box, Tᵤ^{d} is an upper-left vertical coordinate of the upper body detection box, is a lower-right horizontal coordinate of the upper body detection box, and Bᵤ^{d} is a lower-right vertical coordinate of the upper body detection box.

Optionally, the first obtaining unit 1106 is configured to: determine a target image frame, where the target image frame is an image frame in which the to-be-tracked pedestrian appears; and obtain the upper body detection box in a foreground area of the target image frame.

The second obtaining unit 1107 is configured to obtain a detection period whole body box of the to-be-tracked pedestrian based on the upper body detection box.

Optionally the second obtaining unit 1107 is configured to: obtain a lower body scanning area based on the upper body detection box; and if a lower body detection box is obtained by performing lower body detection in the lower body scanning area, obtain the detection period whole body box based on the upper body detection box and the lower body detection box.

The upper body detection box is RECTᵤ^{d}=[Lᵤ^{d},Tᵤ^{d},Rᵤ^{d},Bᵤ^{d}], where Lᵤ^{d} is an upper-left horizontal coordinate of the upper body detection box, Tᵤ^{d} is an upper-left vertical coordinate of the upper body detection box, Rᵤ^{d} is a lower-right horizontal coordinate of the upper body detection box, and Bᵤ^{d} is a lower-right vertical coordinate of the upper body detection box.

Optionally, when obtaining the lower body scanning area based on the upper body detection box, the second obtaining unit 1107 is configured to: determine a first parameter, where the first parameter is

$${B}_{f}^{estimate} = {B}_{u}^{d} - ( {B}_{u}^{d} - {T}_{u}^{d} ) * ( 1 - \frac{1}{{Ratio}_{default}} ) ,$$

where Ratio_{default} is a preset ratio; determine a second parameter, where the second parameter is Wᵤ^{d}=Rᵤ^{d}−Lᵤ^{d}; determine a third parameter, where the third parameter is H_{f}^{estimate}=the first parameter B_{f}^{estimate}−Tᵤ^{d}; and determine the lower body scanning area based on the first parameter, the second parameter, and the third parameter.

Optionally, when obtaining the lower body scanning area based on the upper body detection box, the second obtaining unit 1107 is configured to determine the lower body scanning area based on the first parameter, the second parameter, and the third parameter, where the lower body scanning area is ScanArea=[L^{s},T^{s},R^{s},B^{s}], L^{s} is an upper-left horizontal coordinate of the lower body scanning area, T^{s} is an upper-left vertical coordinate of the lower body scanning area, R^{s} is a lower-right horizontal coordinate of the lower body scanning area, and B^{s} is a lower-right vertical coordinate of the lower body scanning area, where

L^{s}=max{1, Lᵤ^{d}−Wᵤ^{d}/paral1}, T^{s}=max{1, Tᵤ^{d}+H_{f}^{estimate}/paral2}, R^{s}=min{imgW−1, Rᵤ^{d}+Wᵤ^{d}/paral2}, and B^{s}=min{imgH−1, B_{f}^{estimate}+H_{f}^{estimate}Wᵤ^{d}/paral3}.

paral1, paral2 and paral3 are preset values, imgW is a width of any image frame of the to-be-tracked video within the detection period, and imgH is a height of any image frame of the to-be-tracked video within the detection period.

The lower body detection box is RECTₗ^{d}=[Lₗ^{d},Tₗ^{d},Rₗ^{d},Bₗ^{d}], where Lₗ^{d} is an upper-left horizontal coordinate of the lower body detection box, is an upper-left vertical coordinate of the lower body detection box, Rₗ^{d} is a lower-right horizontal coordinate of the lower body detection box, and Bₗ^{d} is a lower-right vertical coordinate of the lower body detection box.

Optionally, when obtaining the detection period whole body box of the to-be-tracked pedestrian based on the upper body detection box, the second obtaining unit 1107 is configured to: determine an upper-left horizontal coordinate of the detection period whole body box, where the upper-left horizontal coordinate of the detection period whole body box is L_{f}^{d}=min (Lᵤ^{d},Lₗ^{d}); determine that an upper-left vertical coordinate of the detection period whole body box is T_{f}^{d}=Tᵤ^{d}; determine that a lower-right horizontal coordinate of the detection period whole body box is R_{f}^{d}=max (Rᵤ^{d}, Rₗ^{d}); determine that a lower-right vertical coordinate of the detection period whole body box is B_{f}^{d}=Bₗ^{d}; and determine that the detection period whole body box is RECT_{f}^{d}=[L_{f}^{d},T_{f}^{d},R_{f}^{d},B_{f}^{d}].

Optionally, when obtaining the detection period whole body box of the to-be-tracked pedestrian based on the upper body detection box, the second obtaining unit 1107 is configured such that if the lower body detection box is not obtained by performing lower body detection in the lower body scanning area, the second obtaining unit 1107 determines an upper-left horizontal coordinate of the detection period whole body box, where the upper-left horizontal coordinate of the detection period whole body box is L_{f}^{d}=Lᵤ^{d}. Additionally, the second obtaining unit 1107 is configured to: determine that an upper-left vertical coordinate of the detection period whole body box is T_{f}^{d}=Tᵤ^{d}; determine that a lower-right horizontal coordinate of the detection period whole body box is R_{f}^{d}=Rᵤ^{d}; determine that a lower-right vertical coordinate of the detection period whole body box is B_{f}^{d}=(Rᵤ^{d}−Lᵤ^{d})*Ratio_{default}+Tᵤ^{d}; and determine that the detection period whole body box is RECT_{f}^{d}=[L_{f}^{d},T_{f}^{d},R_{f}^{d},B_{f}^{d}].

The third obtaining unit 1108 is configured to obtain, within the tracking period, an upper body tracking box of the to-be-tracked pedestrian appearing in the to-be-tracked video.

Optionally, the third obtaining unit 1108 is configured to: scatter a plurality of particles using the upper body detection box as a center, where a ratio of a width to a height of any one of the plurality of particles is the same as a ratio of a width of the upper body detection box to the height of the upper body detection box; and determine the upper body tracking box, where the upper body tracking box is a particle most similar to the upper body detection box among the plurality of particles.

The fourth obtaining unit 1109 is configured to obtain, based on the detection period whole body box, a tracking period whole body box corresponding to the upper body tracking box, where the tracking period whole body box is used to track the to-be-tracked pedestrian.

Optionally, the fourth obtaining unit 1109 is configured to: obtain a preset ratio Ratio_{wh}^{d} of a width of the detection period whole body box to a height of the detection period whole body box; determine that a ratio of a height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} ;$$

and determine the tracking period whole body box based on Ratio_{wh}^{d} and Ratioₕₕ^{d}.

Optionally, the fourth obtaining unit 1109 is configured to: determine that a ratio of a width of the detection period whole body box to a height of the detection period whole body box is

$${Ratio}_{wh}^{d} = \frac{{R}_{f}^{d} - {L}_{f}^{d}}{{B}_{f}^{d} - {T}_{f}^{d}} ;$$

determine that a ratio of a height of the upper body detection box to the height of the detection period whole body box is

$${Ratio}_{hh}^{d} = \frac{{B}_{u}^{d} - {T}_{u}^{d}}{{B}_{f}^{d} - {T}_{f}^{d}} ;$$

and determine the tracking period whole body box based on Ratio_{wh}^{d} and Ratioₕₕ^{d}.

The upper body tracking box is RECTᵤ^{t}=[Lᵤ^{t},Tᵤ^{t},Rᵤ^{t},Bᵤ^{t}], where Lᵤ^{t} is an upper-left horizontal coordinate of the upper body tracking box, Tᵤ^{t} is an upper-left vertical coordinate of the upper body tracking box, Rᵤ^{t} is a lower-right horizontal coordinate of the upper body tracking box, and Bᵤ^{t} is a lower-right vertical coordinate of the upper body tracking box.

Optionally, when determining the tracking period whole body box based on Ratio_{wh}^{d} and Ratioₕₕ^{d}, the fourth obtaining unit 1109 is configured to: determine an upper-left horizontal coordinate of the tracking period whole body box, where if L_{f}^{d}=Lᵤ^{d}, the upper-left horizontal coordinate of the tracking period whole body box is L_{f}^{t}=Lᵤ^{t}; determine that an upper-left vertical coordinate of the tracking period whole body box is T_{f}^{t}=Tᵤ^{t}; determine that a lower-right horizontal coordinate of the tracking period whole body box is R_{f}^{t}=L_{f}^{t}+W_{f}^{t}; determine that a lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}; and determine that the tracking period whole body box is RECT_{f}^{t}=[L_{f}^{t},T_{f}^{t},R_{f}^{t},B_{f}^{t}].

Optionally, the fourth obtaining unit 1109 is configured to: determine the upper-left horizontal coordinate of the tracking period whole body box, where if L_{f}^{d}=Lₗ^{d}, the upper-left horizontal coordinate of the tracking period whole body box is L_{f}^{t}=R_{f}^{t}−W_{f}^{t}; determine that the upper-left vertical coordinate of the tracking period whole body box is T_{f}^{t}=Tᵤ^{t}; determine that the lower-right horizontal coordinate of the tracking period whole body box is R_{f}^{t}=Rᵤ^{t}; determine that the lower-right vertical coordinate of the tracking period whole body box is

$${B}_{f}^{t} = \frac{{B}_{u}^{t} - {T}_{u}^{t}}{{Ratio}_{hh}^{d}} + {T}_{f}^{t} ,$$

where W_{f}^{t}=(B_{f}^{t}−T_{f}^{t})*Ratio_{wh}^{d}; and determine that the tracking period whole body box is RECT_{f}^{t}=[L_{f}^{t},T_{f}^{t},R_{f}^{t},B_{f}^{t}].

For a process of performing the pedestrian tracking method by the electronic device shown in this embodiment, refer to the foregoing embodiments. Details are not described in this embodiment.

For descriptions of beneficial effects achieved by performing the pedestrian tracking method by the electronic device shown in this embodiment, refer to the foregoing embodiments. Details are not described in this embodiment.

It is to be understood that, for purposes of convenience and brevity, for a detailed working process of the foregoing system, apparatus, and unit, refer to a corresponding process in the foregoing method embodiments. Details are not described herein again.

In the embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present disclosure may be integrated into one processor, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to other approaches, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing embodiments are merely intended for describing the technical solutions of the present disclosure, but not for limiting the present disclosure. Although the present disclosure is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

1. A pedestrian tracking method, comprising:
obtaining, within a detection period, an upper body detection box of a body of a to-be-tracked pedestrian appearing in a to-be-detected video;
obtaining a detection period body box of the to-be-tracked pedestrian based on the upper body detection box;
obtaining, within a tracking period, an upper body tracking box of a to-be-tracked pedestrian appearing in a to-be-tracked video; and
obtaining, based on the detection period body box, a tracking period body box corresponding to the upper body tracking box;
tracking the to-be-tracked pedestrian by using the tracking period body box.

2. The method according to claim 1, further comprising:
obtaining a lower body scanning area based on the upper body detection box; and
obtaining the detection period body box based on the upper body detection box and a lower body detection box when the lower body detection box is obtained by performing lower body detection in the lower body scanning area.

3. The method according to claim 2, wherein the upper body detection box is RECTᵤ^{d}=[Lᵤ^{d},Tᵤ^{d},Rᵤ^{d},Bᵤ^{d}], wherein Lᵤ^{d} is an upper-left horizontal coordinate of the upper body detection box, wherein Tᵤ^{d} is an upper-left vertical coordinate of the upper body detection box, wherein Rᵤ^{d} is a lower-right horizontal coordinate of the upper body detection box, wherein Bᵤ^{d} is a lower-right vertical coordinate of the upper body detection box and wherein obtaining the lower body scanning area based on the upper body detection box comprises:
determining a first parameter, wherein the first parameter is
$${B}_{f}^{estimate} = {B}_{u}^{d} - ( {B}_{u}^{d} - {T}_{u}^{d} ) * ( 1 - \frac{1}{{Ratio}_{default}} ) ,$$
wherein Ratio_{default} is a preset ratio;
determining a second parameter, wherein the second parameter is Wᵤ^{d}=Rᵤ^{d}−Lᵤ^{d};
determining a third parameter, wherein the third parameter is H_{f}^{estimate}=the first parameter B_{f}^{estimate}−Tᵤ^{d}; and
determining the lower body scanning area based on the first parameter, the second parameter, and the third parameter.

4. The method according to claim 1, wherein obtaining, within the tracking period, the upper body tracking box of the to-be-tracked pedestrian appearing in the to-be-tracked video comprises:
scattering a plurality of particles using the upper body detection box as a center, wherein a ratio of a width to a height of any one of the plurality of particles is the same as a ratio of a width of the upper body detection box to the height of the upper body detection box; and
determining the upper body tracking box, wherein the upper body tracking box is a particle most similar to the upper body detection box among the plurality of particles.

5. The method according to claim 1, further comprising:
obtaining a target image frame sequence of the to-be-detected video, wherein the target image frame sequence comprises one or more consecutive image frames, and wherein the target image frame sequence is before the detection period;
obtaining a background area of the to-be-detected video based on the target image frame sequence;
obtaining a foreground area of any image frame of the to-be-detected video by subtracting the background area from the image frame of the to-be-detected video within the detection period; and
obtaining the to-be-tracked pedestrian by detecting the foreground area of the image frame of the to-be-detected video.

6. The method according to claim 5, wherein obtaining the upper body detection box of the to-be-detected pedestrian appearing in the to-be-tracked video comprises:
determining a target image frame in which the to-be-tracked pedestrian appears; and
obtaining the upper body detection box in a foreground area of the target image frame.

7. The method according to claim 1, wherein: the to-be-tracked video and the to-be-detected video are different parts of the same video.

8. The method according to claim 1, wherein the upper body detection box is obtained based on a whole body of the to-be-tracked pedestrian.

9. The method according to claim 1, further comprising obtaining, within the tracking period based on the upper body detection box, the upper body tracking box of the to-be-tracked pedestrian appearing in the to-be-tracked video.

10. An electronic device for tracking a pedestrian, comprising:
a memory comprising instructions; and
one or more processors in communication with the memory and configured to execute the instructions to:
obtain, within a detection period, an upper body detection box of a to-be-tracked pedestrian appearing in a to-be-detected video;
obtain a detection period body box of the to-be-tracked pedestrian based on the upper body detection box;
obtain, within a tracking period, an upper body tracking box of the to-be-tracked pedestrian appearing in a to-be-tracked video;
obtain, based on the detection period body box, a tracking period body box corresponding to the upper body tracking box; and
track, using the tracking period body box, the to-be-tracked pedestrian.

11. The electronic device according to claim 10, wherein the one or more processors are further configured to:
obtain a lower body scanning area based on the upper body detection box; and
obtain the detection period body box based on the upper body detection box and a lower body detection box when the lower body detection box is obtained by performing lower body detection in the lower body scanning area.

12. The electronic device according to claim 11, wherein the one or more processors are further configured to:
scatter a plurality of particles using the upper body detection box as a center, wherein a ratio of a width to a height of any one of the plurality of particles is the same as a ratio of a width of the upper body detection box to the height of the upper body detection box; and
determine the upper body tracking box, wherein the upper body tracking box is a particle most similar to the upper body detection box among the plurality of particles.

13. The electronic device according to 12, wherein the one or more processors are further configured to:
obtain a target image frame sequence of the to-be-detected video, wherein the target image frame sequence comprises one or more consecutive image frames, and wherein the target image frame sequence is before the detection period;
obtain a background area of the to-be-detected video based on the target image frame sequence;
obtain a foreground area of any image frame of the to-be-detected video by subtracting the background area from the image frame of the to-be-detected video within the detection period; and
obtain the to-be-tracked pedestrian by detecting the foreground area of the image frame of the to-be-detected video.

14. The electronic device according to claim 10, wherein the one or more processors are further configured to:
determine a target image frame in which the to-be-tracked pedestrian appears; and
obtain the upper body detection box in a foreground area of the target image frame.

15. The electronic device according to claim 10, wherein: the to-be-tracked video and the to-be-detected video are different parts of the same video.

16. The electronic device according to claim 10, wherein: the upper body detection box is obtained based on a whole body of the to-be-tracked pedestrian.

17. The electronic device according to claim 10, the one or more processors are further configured to obtain, within the tracking period based on the upper body detection box, the upper body tracking box of the to-be-tracked pedestrian appearing in the to-be-tracked video.

18. A computer program product comprising computer-executable instructions for tracking a pedestrian, that, when executed by one or more processors of an electronic device, cause the one or more processors to:
obtain, within a detection period, an upper body detection box of a to-be-tracked pedestrian appearing in a to-be-detected video;
obtain a detection period body box of the to-be-tracked pedestrian based on the upper body detection box;
obtain, within a tracking period, an upper body tracking box of the to-be-tracked pedestrian appearing in a to-be-tracked video;
obtain, based on the detection period body box, a tracking period body box corresponding to the upper body tracking box; and
track, using the tracking period body box, the to-be-tracked pedestrian.

19. The computer program product according to claim 18, wherein the one or more processors are further configured to:
obtain a lower body scanning area based on the upper body detection box; and
obtain the detection period body box based on the upper body detection box and a lower body detection box when the lower body detection box is obtained by performing lower body detection in the lower body scanning area.

20. A pedestrian tracking method, comprising:
obtaining, within a detection period, an upper body detection box of a to-be-tracked pedestrian appearing in a to-be-detected video and a body detection box of the to-be-tracked pedestrian appearing in the to-be-detected video;
obtaining, within a tracking period, an upper body tracking box of the to-be-tracked pedestrian appearing in a to-be-tracked video;
obtaining, based on upper body tracking box and a relationship between the upper body detection box and the body detection box, a body tracking box corresponding to the upper body tracking box; and
tracking the to-be-tracked pedestrian using the body tracking box.

21. The pedestrian tracking method according to claim 20, wherein the relationship between the upper body detection box and the body detection box indicates a ratio between the upper body detection box and the body detection box.

22. The pedestrian tracking method according to claim 20, further comprising:
obtaining a lower body detection box based on the upper body detection box; and
obtaining the body tracking box corresponding to the upper body tracking box.

23. The pedestrian tracking method according to claim 20, wherein the to-be-tracked video and the to-be-detected video are different parts of the same video.

24. The method according to claim 20, wherein the upper body detection box is obtained based on a whole body of the to-be-tracked pedestrian.

25. An electronic device for tracking pedestrian, comprising:
an interface; and
one or more processors in communication with the interface and configured to execute an instructions to:
obtain within a detection period, an upper body detection box of a to-be-tracked pedestrian appearing in a to-be-detected video and a body detection box of the to-be-tracked pedestrian appearing in a to-be-detected video;
obtain within a tracking period, an upper body tracking box of the to-be-tracked pedestrian appearing in a to-be-tracked video;
obtain based on upper body tracking box and a relationship between the upper body detection box and the body detection box, a body tracking box corresponding to the upper body tracking box; and
track the to-be-tracked pedestrian using the body tracking box.

26. The electronic device according to claim 25, wherein: the to-be-tracked video and the to-be-detected video are different parts of the same video.

27. The electronic device according to claim 25, wherein the one or more processors are further configured to obtain, within the tracking period based on the upper body detection box, the upper body tracking box of the to-be-tracked pedestrian appearing in the to-be-tracked video.
